(19) United States
(12) Patent Application Publication
(10) Pub. No.: US 2026/0291888 A1
(43) Pub. Date: Sep. 24, 2026

(54) SYSTEM

(71) Applicant: SoftBank Group Corp., Tokyo (JP)

(72) Inventor: Toshiyuki NAKATANI, Tokyo (JP)

(73) Assignee: SoftBank Group Corp., Tokyo (JP)

(21) Appl. No.: 19/567,282

(22) Filed: Mar. 16, 2026

(30) Foreign Application Priority Data
Mar. 19, 2025 (JP) 2025-045244

(51) Int. Cl. H04L 51/02; G06N 3/0475; G06V 30/19

(52) U.S. Cl. CPC H04L 51/02; G06N 3/0475; G06V 30/19173

(57) ABSTRACT

A system includes a processor that is configured to collect, from a database, answer data and behavior history of a student in order to analyze a vocabulary ability and a comprehension level of the student, analyze the collected data by using natural language processing techniques and use a generative artificial intelligence model, based on an analysis result, to provide a text at an appropriate difficulty level, and analyze an emotional state of the student in real time and adjust learning content based on a result of the analysis of the emotional state.

### CROSS-REFERENCE TO RELATED APPLICATION

This application is based on and claims priority under 35 USC 119 from Japanese Patent Application No. 2025-045244 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-assisted learning systems generally present fixed learning content that does not adequately adapt to an individual student's vocabulary ability, comprehension level, or emotional state. Such systems typically rely on simple scoring rules or static difficulty settings, and therefore fail to dynamically tailor texts and exercises to the needs and current condition of each student. As a result, when the presented text is too easy, the student may lose motivation and fail to improve vocabulary or comprehension; conversely, when the text is too difficult, the student may feel frustration, leading to poor learning outcomes and disengagement. Furthermore, many conventional systems do not effectively utilize accumulated answer data and behavior history stored in databases, and they do not apply advanced natural language processing techniques or generative artificial intelligence models to select or generate appropriate texts. In addition, conventional systems generally ignore the student's emotional state during learning, and thus cannot adjust content in response to stress, boredom, or confusion. Therefore, there is a need for a system that analyzes a student's vocabulary ability, comprehension level, and emotional state in real time, utilizes historical data through natural language processing and a generative artificial intelligence model, and automatically adjusts both the difficulty and the type of learning content, while also monitoring learning progress and verifying comprehension with interactive questions and quizzes.

### SUMMARY

In order to solve the foregoing problems, the present invention provides a system comprising a processor, wherein the processor is configured to collect, from a database, answer data and behavior history of a student in order to analyze a vocabulary ability and a comprehension level of the student, analyze the collected data by using natural language processing techniques and use a generative artificial intelligence model, based on an analysis result, to provide a text at an appropriate difficulty level, and analyze an emotional state of the student in real time and adjust learning content based on a result of the analysis of the emotional state. According to an aspect of the invention, the processor is further configured to monitor a learning progress of the student and automatically update content based on progress data, whereby new texts, exercises, or review materials are selected or generated in accordance with the degree of completion and performance over time. According to another aspect of the invention, the processor is further configured to generate interactive questions or quizzes and confirm the comprehension level of the student by using answers to the interactive questions or quizzes, and to feed the confirmed comprehension level back into the analysis of the vocabulary ability and comprehension level. Through these configurations, the system dynamically adapts the difficulty and type of content, reflects both historical and real-time data including the emotional state of the student, and thereby improves learning efficiency, maintains student engagement, and enhances the effectiveness of individualized education.

The term “system” refers to an arrangement including at least one processor and associated hardware and software components that cooperate to perform the functions described in the claims.

The term “processor” refers to one or more hardware processing units, such as a central processing unit (CPU), a graphics processing unit (GPU), a microcontroller, or a combination thereof, configured to execute instructions to perform the claimed operations.

The term “database” refers to any structured or unstructured data storage system, including relational databases, NoSQL databases, data warehouses, or other electronic storage devices, in which answer data, behavior history, and other learning-related information are stored and managed.

The term “answer data” refers to information indicating responses provided by a student to questions, quizzes, exercises, or other learning tasks, including correctness, selected options, textual answers, timestamps, and related metadata.

The term “behavior history” refers to data representing a student's interactions with the learning system over time, including accessed content, time spent on tasks, navigation actions, frequency of use, and patterns of engagement.

The term “student” refers to any user of the system who receives learning content and whose vocabulary ability, comprehension level, and emotional state are analyzed for educational purposes.

The term “vocabulary ability” refers to a measure or estimation of the breadth and depth of words and expressions that a student can recognize, understand, and appropriately use within the context of the learning content.

The term “comprehension level” refers to a measure or estimation of the degree to which a student correctly understands the meaning, structure, and implications of presented texts or learning materials.

The term “natural language processing techniques” refers to computational methods and algorithms for processing and analyzing human language data, including but not limited to tokenization, part-of-speech tagging, syntactic parsing, semantic analysis, sentiment analysis, and text classification.

The term “generative artificial intelligence model” refers to a machine learning model configured to generate text or other content, such as a large language model, sequence-to-sequence model, or transformer-based model, that can produce new sentences or texts based on input data and learned parameters.

The term “text at an appropriate difficulty level” refers to a textual learning material whose complexity, including vocabulary, sentence structure, and conceptual depth, is selected or generated so as to be suitable for the current vocabulary ability and comprehension level of the student.

The term “emotional state” refers to an inferred or detected psychological condition of the student, such as stress, boredom, confusion, engagement, or motivation, determined based on interaction data, sensor data, or other observable indicators.

The term “learning content” refers to any educational material provided to the student, including texts, exercises, questions, quizzes, multimedia content, explanations, and feedback messages.

The term “learning progress” refers to information indicating how far the student has advanced in the learning process, including completed tasks, performance history, current stage or level, and trends over time.

The term “content” refers to specific learning items or materials provided by the system, such as reading passages, practice problems, quizzes, review modules, and related instructional resources.

The term “interactive questions or quizzes” refers to questions, problem sets, or assessments that require active responses from the student and for which the system can record, evaluate, and use the answers to assess understanding.

The term “confirm the comprehension level” refers to determining or validating the degree of understanding of the student with respect to particular content, based on analysis of the student's answers to the interactive questions or quizzes.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

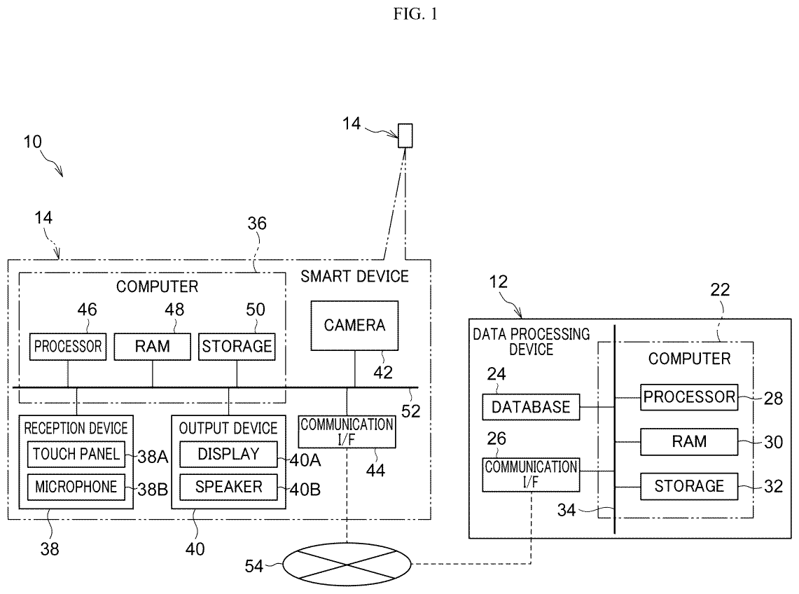

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

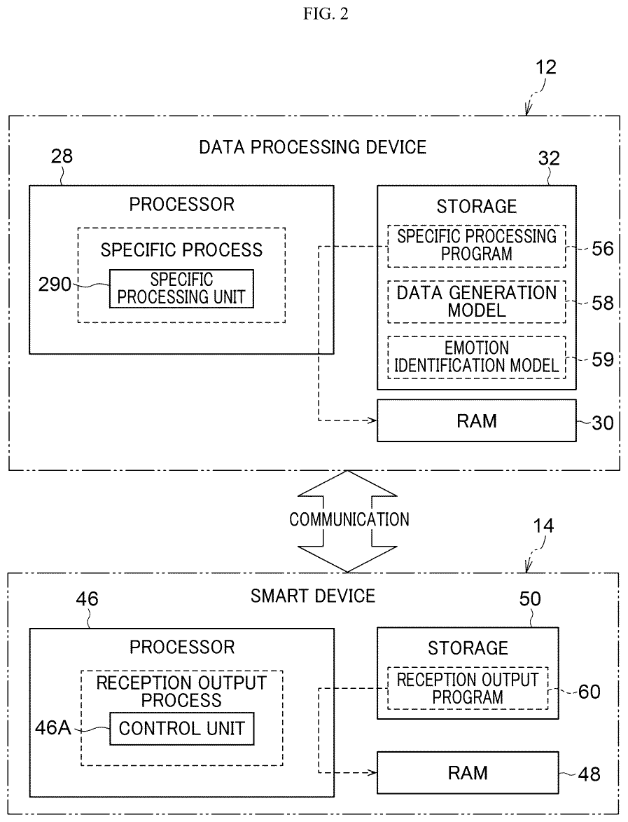

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented educational systems typically rely on fixed rule-based scoring or simple keyword matching to estimate learner comprehension and vocabulary level. Such systems often process learner input in a shallow manner, without performing robust normalization, tokenization, stop-word removal, and syntactic analysis tailored to downstream machine learning models. As a result, the underlying computing resources are not efficiently utilized, and the systems frequently produce unstable difficulty estimations and noisy comprehension evaluations, which in turn degrades the quality of subsequent adaptive content selection.

In addition, existing systems that attempt to use large-scale generative models typically submit raw text to the model with ad hoc or poorly structured prompts. This lack of systematic prompt construction, conditioning, and parameter control leads to inconsistent outputs, unnecessary token consumption, and increased latency and cost at the computing infrastructure level. The generative model is not effectively integrated with precomputed linguistic features such as statistical and syntactic complexity indices, and therefore cannot fully exploit the available structured data to generate reliable evaluation information or interactive questions.

Furthermore, many adaptive learning platforms do not maintain a coherent time-series representation of learner input, difficulty indices, comprehension scores, and vocabulary usage levels at the system level. Without such structured accumulation and algorithmic use of longitudinal data, the processor cannot optimize the way it constructs prompts or selects content. This causes inefficient use of storage and computation, and prevents the system from dynamically tuning model inputs and outputs to the learner's evolving state in a technically rigorous way.

Accordingly, there is a need for an improved computer-implemented educational assessment and content-delivery system in which a processor performs integrated natural language preprocessing, structured feature extraction, difficulty index computation, vocabulary-level estimation, and prompt-based interaction with a generative AI model, and in which the processor leverages time-series learning data to dynamically control prompt conditions and content selection. Such a system should improve the technical functioning of the underlying computing environment by stabilizing model behavior, reducing unnecessary computation, and generating more machine-usable evaluation information, thereby enabling more accurate and efficient adaptive learning operations.

The specific processing by the specific processing unit 290 of the data processing device 12 in Example 1 is realized by the following means.

The present invention provides a server comprising a processor and a memory storing instructions which, when executed by the processor, cause the processor to acquire learner input information including a text passage and an answer from a terminal device, preprocess the learner input information by normalizing character strings, segmenting the character strings into word units, removing unnecessary words, and converting the preprocessed data into an analysis data structure, calculate statistical features and syntactic features based on the analysis data structure, calculate a difficulty index of the text passage based on the statistical features and the syntactic features, generate an evaluation input including the text passage and the learner answer as a prompt sentence in a natural language format, input the prompt sentence into a generative model to obtain evaluation information relating to a comprehension level of the learner, classify words included in the text passage and the learner answer based on frequency information or vocabulary level information to calculate a vocabulary usage level, integrate the difficulty index, the evaluation information relating to the comprehension level, and the vocabulary usage level to select a learning text or a problem adapted to an ability level of the learner and generate presentation information including the selected learning text or the selected problem, transmit the presentation information to the terminal device and cause the terminal device to display an evaluation result and learning content, and generate, based on the evaluation information relating to the comprehension level and learning history information stored in a storage device, a further prompt sentence for the generative model and automatically generate interactive questions for comprehension checking by using the further prompt sentence with the generative model. This enables the computing system to perform structured linguistic preprocessing and feature computation that stabilizes subsequent generative model behavior, to construct and adapt prompt sentences in a data-driven manner using time-series learner information, to reduce unnecessary processing and variability in model outputs, and to deliver more accurate and computationally efficient adaptive assessments and learning content.

The term “learner input information” refers to information including at least a text passage and an answer input by a learner or on behalf of a learner via a terminal device and transmitted to the server for analysis.

The term “terminal device” refers to an electronic device operated by a user, such as a computing device with a display and an input interface, that communicates with the server to send learner input information and to present evaluation results and learning content.

The term “preprocess” refers to performing one or more operations on raw text data, including normalizing character strings, segmenting the text into word units, removing unnecessary words, and converting the processed text into a data structure suitable for computational analysis.

The term “normalizing character strings” refers to converting text to a standardized format, including at least one of converting characters to a uniform case, removing or standardizing whitespace, and unifying character encodings.

The term “segmenting the character strings into word units” refers to dividing a text string into discrete tokens that correspond to words or word-like units, using a computational tokenization procedure.

The term “unnecessary words” refers to words or tokens that are deemed non-informative for a given analysis, including at least function words, high-frequency stop words, or symbols, which can be removed without materially affecting the intended linguistic evaluation.

The term “analysis data structure” refers to a machine-readable representation of preprocessed text, such as a list, array, or graph of tokens, features, or annotations, which is used as input for further computational processing.

The term “statistical features” refers to numerical values computed from the analysis data structure, including at least word counts, sentence lengths, type-token ratios, and frequency-based measures of vocabulary usage.

The term “syntactic features” refers to information relating to the grammatical structure of text, including at least part-of-speech patterns, dependency relations, clause counts, and indicators of grammatical complexity.

The term “difficulty index” refers to a numerical value or level representing an estimated difficulty of a text passage for a learner, computed based on at least statistical features and syntactic features of the passage.

The term “evaluation input” refers to a text-based input constructed from at least a text passage and a learner answer, which is formatted as a prompt sentence in a natural language and provided to a generative AI model for processing.

The term “prompt sentence” refers to a natural language instruction text that specifies a task or query to a generative AI model and includes contextual information such as a text passage, a learner answer, or prior evaluation results.

The term “generative AI model” refers to a machine-learned model configured to generate text outputs in response to input text, which may include a large language model trained on textual data and capable of producing evaluation information or questions.

The term “evaluation information relating to a comprehension level” refers to information generated based on a learner answer and a text passage, including at least a numerical score or rating indicating how well the learner understands the passage and optionally explanatory feedback.

The term “frequency information” refers to data indicating how often particular words appear in one or more corpora, which can be used to determine whether a word is common, uncommon, or specialized.

The term “vocabulary level information” refers to data that associates words with difficulty or proficiency levels, such as levels in a graded vocabulary list, and that is used to classify words according to learner proficiency stages.

The term “vocabulary usage level” refers to a numerical value or categorical level that represents the sophistication or breadth of vocabulary used by a learner, computed based on frequency information and vocabulary level information.

The term “ability level of the learner” refers to a representation of a learner's proficiency in at least comprehension and vocabulary, derived from computed indices including the difficulty index, evaluation information relating to the comprehension level, and the vocabulary usage level.

The term “learning text” refers to a text passage selected or generated for study by a learner, whose difficulty and content are adapted to match the ability level of the learner.

The term “problem” refers to an exercise, question, or task presented to a learner for the purpose of assessing or improving understanding of a text or concept.

The term “presentation information” refers to data including at least one of a selected learning text, a selected problem, evaluation results, or feedback, which is formatted for display on a terminal device.

The term “evaluation result” refers to information summarizing outcomes of the analysis performed on learner input, including at least the difficulty index, the comprehension-level evaluation information, and the vocabulary usage level.

The term “learning content” refers to instructional material provided to a learner, including at least texts, problems, explanations, and interactive questions, selected or generated based on the learner's ability level.

The term “learning history information” refers to time-series data relating to a learner's past interactions, including at least prior learner input information, prior difficulty indices, comprehension evaluations, vocabulary usage levels, and previously presented content.

The term “interactive questions” refers to questions generated for a learner that require active responses, including at least open-ended questions, multiple-choice questions, or short-answer questions, used to confirm or deepen comprehension.

The term “time series” refers to a sequence of data points associated with chronological information, where each point corresponds to a particular learner interaction or evaluation at a specific time.

The term “learning progress” refers to an indication of changes over time in a learner's ability level, computed based on time-series learning history information including difficulty indices, comprehension evaluations, and vocabulary usage levels.

The term “condition or parameter of the prompt sentence” refers to at least one controllable element of a prompt sentence or a generative AI model call, including phrasing, requested output format, difficulty constraints, model temperature, or token limits, which can be adjusted based on learning progress.

The term “follow-up question for additional input” refers to a question generated after an initial assessment, which is designed to gather further responses from a learner for clarifying or reinforcing comprehension.

The term “explanatory text” refers to a text generated or selected to explain concepts, correct misunderstandings, or provide detailed feedback related to a text passage or a learner's answer.

The term “candidate for a next learning task” refers to a proposed subsequent learning text, problem, or set of activities chosen or generated based on current evaluation information and difficulty index, for continued study by the learner.

In one embodiment, a server implements the claimed system using a general-purpose computer platform including at least one central processing unit (CPU), an optional graphics processing unit (GPU), a main memory, a non-volatile storage device, and a network interface. The server executes an operating system such as a general-purpose server operating system, and runs an application layer based on a programming language runtime such as a Python runtime environment. The server loads software libraries for natural language processing, for example, a tokenization and stop-word processing toolkit such as NLTK and a syntactic analysis toolkit such as spaCy, as well as a machine learning framework such as a deep learning framework. The server further accesses a generative AI model implemented as a large-scale neural network, either deployed locally on the GPU or exposed via an external model serving interface.

The terminal is a client-side computing device operated by a user, such as a tablet computer, a smartphone, or a personal computer, equipped with a display, an input interface (touchscreen, keyboard, or pointing device), a local processor, a memory, and a communication unit. The terminal executes a web browser or a dedicated application to render user interfaces received from the server, to collect learner input information, and to display evaluation results and learning content.

The user operates the terminal to input learner data. The user selects or enters a text passage to be read by a learner and inputs one or more learner answers in natural language form. The terminal converts these inputs into a structured data object, for example, a hierarchical data structure representing at least a passage, a question, and a learner answer as string fields. The terminal then transmits this structured data object to the server over a network communication link using a secure transport protocol.

The server receives the structured learner input information and stores it in a storage subsystem such as a relational database system. The server maintains one or more database tables that record a learner identifier, a timestamp, the raw text passage, the raw learner answer, and subsequent derived values such as a difficulty index, comprehension scores, and vocabulary usage levels. The server thereby preserves a time-series representation of learning history information which is used for later processing and for dynamically adapting model behavior.

The server preprocesses the learner input information to construct an analysis data structure. The server normalizes the character strings by converting them to a uniform case, unifying whitespace, and standardizing character encodings. The server performs tokenization using a computational tokenization function, which decomposes each input string into a sequence of tokens. The server then eliminates unnecessary words using a predefined stop-word list, implemented as a hash-based lookup table in memory. The server constructs an internal representation such as an array or list of tokens with associated metadata, including token position indices and part-of-speech placeholders, and stores this as the analysis data structure in the memory. This structured representation improves downstream computational efficiency because each subsequent module reads a well-defined data structure rather than unstructured text.

The server analyzes syntactic and statistical properties of the passage and the learner answer. The server applies a syntactic analysis component, for example, a dependency parser implemented in a language processing engine, to the passage and generates a parse tree or dependency graph structure. The server computes syntactic features such as the number of clauses per sentence, the depth of the dependency tree, and the distribution of part-of-speech tags. The server also computes statistical features including the total number of tokens, the number of unique tokens, the type-token ratio, the average sentence length, and the frequency distribution of content words. The server combines these values into a feature vector, implemented as a numerical array or key-value map, which is fed into a difficulty estimation module.

The server calculates a difficulty index for the passage based on the computed features. The server may employ a regression model such as a tree-based regressor or a linear regressor trained on labeled corpora where each text is annotated with a difficulty level. The server uses the feature vector as an input to the regression model, executes a sequence of numerical operations including weighted summations and threshold comparisons, and obtains a scalar difficulty index output. The server normalizes this scalar into a human-interpretable scale, for example from 0 to 100 or across discrete difficulty levels. By using syntactic and statistical features that are specifically engineered for machine consumption, the server improves the stability and discriminative power of difficulty estimation compared with naïve rule-based approaches.

The server estimates a vocabulary usage level for the learner by linking tokens to vocabulary level information. The server stores a vocabulary table in a database, where each lexical item is associated with frequency information and a graded difficulty level. The server maps tokens in the learner answer and the passage to entries in the vocabulary table, counts tokens by level category, and computes ratios of advanced to basic terms. The server then derives a vocabulary usage level value, which may be a discrete category or a continuous score. Because the vocabulary table is indexed and the counts are computed on tokenized data structures, the server performs these operations with low computational overhead, thereby improving processing speed when large corpora of learner interactions are analyzed.

The server constructs a prompt sentence for a generative AI model based on the analysis results. The server composes a natural language string that includes at least the passage text, the learner answer, and instructions specifying the desired output format, such as a comprehension score and feedback. The server can also insert the previously computed difficulty index or vocabulary usage level into the prompt sentence to condition the model's behavior. For example, the server may generate a prompt sentence such as:

“You are an educational assessment assistant. Given the passage and the student's answer below, (1) rate the student's comprehension on a scale from 0 to 100, and (2) provide brief feedback for improvement. Passage: [PASSAGE_TEXT]. Student answer: [ANSWER_TEXT]. Return: comprehension score and feedback.”

The server replaces the placeholders [PASSAGE_TEXT] and [ANSWER_TEXT] with the actual text data before sending the prompt sentence to the generative AI model.

In another example, the server may construct a prompt sentence for generating further diagnostic questions, such as:

“Generate three short questions to check a student's understanding of the following passage. Make the questions suitable for a learner whose comprehension score is [COMPREHENSION_SCORE] out of 100. Passage: [PASSAGE_TEXT].”

The server again replaces the placeholders with the actual score and passage and transmits the completed prompt to the generative AI model.

The server interfaces with a generative AI model implemented as a neural network. In one embodiment, the generative AI model is a transformer-based large language model comprising multiple self-attention layers, feed-forward layers, and layer-normalization components. The model is trained on textual training data using stochastic gradient descent optimization and a loss function such as cross-entropy that measures divergence between predicted token distributions and actual tokens. The model parameters (weights) are stored in a matrix form in the model's internal storage, and inference involves matrix multiplication, non-linear activation, and attention operations over token embeddings. The server calls a model serving component, passing the tokenized prompt sentence and configured hyperparameters such as temperature, top-k sampling, or maximum output length.

The server controls model behavior by adjusting these hyperparameters and by constraining output format through the content of the prompt sentence. Because the server uses precomputed structured features and a controlled prompt pattern, the system reduces randomness in model outputs and avoids unnecessary exploration of token space. This leads to more consistent evaluation information and shorter responses, which reduce both computation time and network transmission volume. From a computer technology perspective, this structured interaction with the generative AI model efficiently exploits the model's capacity and reduces hardware resource consumption.

The server parses the output generated by the generative AI model. The output is a text sequence that follows the instructions embedded in the prompt sentence. The server applies deterministic parsing rules or simple pattern matching to extract numerical values such as a comprehension score and textual feedback. The server validates that extracted scores are within pre-defined bounds and may rescale them if necessary. The server then stores the evaluation information relating to the comprehension level, together with timestamps and associated difficulty indices, in the database as part of the learning history information.

The server uses the stored time-series learning history information to adapt subsequent processing. The server analyzes trends in difficulty indices, comprehension scores, and vocabulary usage levels for each learner. The server computes moving averages or other statistical aggregations and determines an ability level for the learner at a given time. Based on this ability level, the server selects appropriate ranges for difficulty indices when retrieving candidate learning texts or problems from a content repository. The server also modifies the conditions or parameters of subsequent prompt sentences, for example, by specifying that the generative AI model should generate simpler explanations or more challenging questions depending on the learner's progress. This dynamic prompt adaptation is not a mere automation of human selection; it modifies how the computer constructs instructions to a neural network using structured historical data, thereby changing internal computational pathways and improving output relevance.

The server generates interactive questions and explanatory texts as part of adaptive learning content. When evaluation information indicates that comprehension is within a certain range, the server constructs new prompt sentences for the generative AI model that request follow-up questions, clarifications, or next-step tasks. For example, the server may construct a prompt sentence such as:

“Based on the following passage and the student's current comprehension, create two follow-up questions that target the student's weak points and one short explanatory text. Passage: [PASSAGE_TEXT]. Student comprehension score: [COMPREHENSION_SCORE].”

By embedding specific difficulty and comprehension context into the prompt, the server ensures that the generative AI model produces output that aligns with structured data computed by the system, improving both accuracy and computational efficiency.

The terminal receives the resulting presentation information from the server, which includes selected learning texts, problems, evaluation results, feedback, and interactive questions. The terminal renders this information in graphical form, potentially with visualization elements such as progress bars or charts. The user views the displayed evaluation results and content, and can initiate further interactions, such as answering new questions or requesting additional explanations. The terminal may also locally cache certain content to reduce repeated network requests, thus further reducing communication load.

In another embodiment, the server deploys the generative AI model locally on a GPU-equipped computing node. The server converts the prompt sentence into a sequence of token identifiers using a tokenizer stored in the model interface module, loads model weights from a local storage device into GPU memory, and performs inference operations entirely within the data center. In this case, the server can further reduce latency and improve throughput by batching multiple prompt sentences together and by using optimized tensor computation libraries. The combination of precomputation of difficulty indices and vocabulary usage levels with batched inference enables the server to allocate GPU cycles more efficiently, increasing the number of learners the system can serve simultaneously.

In yet another embodiment, the server employs a hybrid architecture in which some components, such as tokenization and feature calculation, are executed on the CPU, while neural network inference for the generative AI model is offloaded to the GPU. The server uses asynchronous input-output operations and queuing mechanisms to schedule requests to the model. This architecture reduces idle times for both CPU and GPU, thereby improving overall system throughput and responsiveness.

The described configurations provide technical effects beyond mere automation of human assessment tasks. By explicitly structuring text into analysis data structures, computing specialized syntactic and statistical features, and integrating those features into prompt construction and adaptive control of a generative AI model, the server reduces computational redundancy, improves stability and predictability of model outputs, and lowers communication load between the server and the model interface. The system uses non-conventional steps such as feature-based difficulty indexing, vocabulary-level mapping, and time-series-conditioned prompt control, which are tailored to the capabilities and limitations of large neural networks. These non-standard processing sequences yield improved accuracy in comprehension estimation, faster content adaptation, reduced variance in generative outputs, and better utilization of hardware resources, amounting to an improvement in computer technology itself.

Multiple variations are possible within the scope of this embodiment. The server may use alternative natural language processing toolkits, alternative syntactic parsers, or different types of regression models for difficulty estimation. The generative AI model may be any neural network architecture that processes token sequences, including recurrent neural networks, convolutional sequence models, or transformer-based models, trained with different optimization algorithms or loss functions. The server may adjust the degree of preprocessing, the set of syntactic and statistical features, and the mapping from feature vectors to difficulty indices. The server may store learning history information in different data structures, such as time-series databases or key-value stores, and may use different algorithms, such as clustering or reinforcement learning, to adjust prompt sentences and content selection. The essential technical characteristic is that the server utilizes structured computational processing of text and learner data, in combination with controlled interaction with a generative AI model through prompt sentences, to achieve improved processing efficiency, accuracy, and system performance compared with conventional approaches.

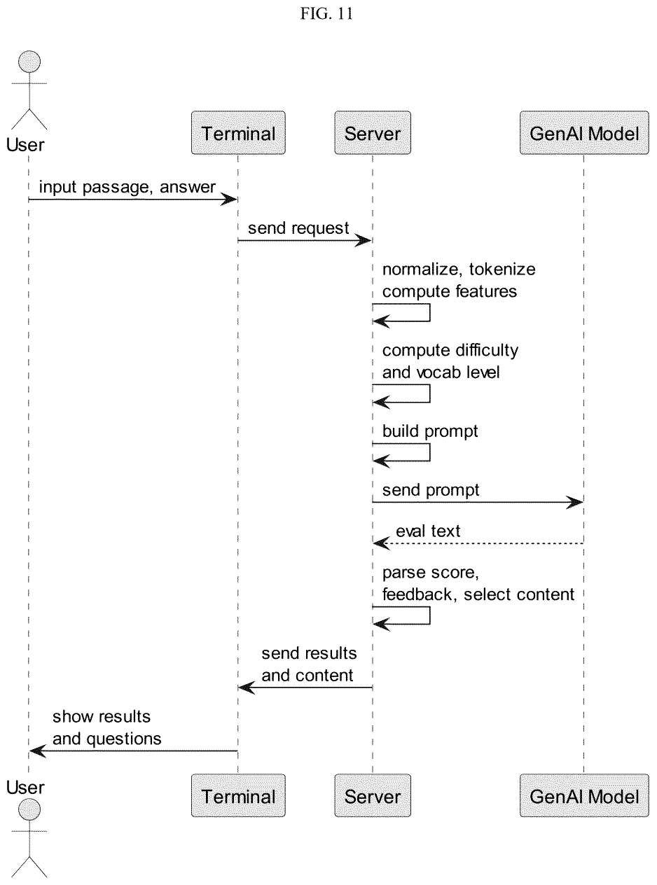

The following describes the processing flow using FIG. 11.

### Step 1

The user operates the terminal to input learner data.

The user enters at least one text passage and at least one learner answer into input fields displayed on the terminal.

The terminal receives raw text strings as input and stores them temporarily in a local data structure including fields such as passage, question, and learner_answer.

The terminal validates that mandatory fields are not empty and that text lengths are within predefined limits, and the terminal outputs a structured data object containing the validated text fields.

### Step 2

The terminal prepares a transmission payload for the server.

The terminal takes the structured data object as input and serializes the passage, question, and learner_answer fields into a hierarchical message format.

The terminal appends metadata such as a learner identifier, a device identifier, and a timestamp, and the terminal outputs a complete request payload.

The terminal transmits the request payload to the server over a network connection using a secure communication protocol.

### Step 3

The server receives and stores the learner input information.

The server takes the request payload from the terminal as input and deserializes the message to retrieve the passage, question, learner_answer, and associated metadata.

The server inserts a new record into a learning history data store, writing the raw text fields and metadata into a database table, and the server assigns a unique analysis identifier.

The server outputs the analysis identifier and the raw text strings to subsequent processing modules in memory.

### Step 4

The server performs text normalization on the received strings.

The server takes the raw passage and learner_answer strings as input and applies normalization operations, including converting all alphabetic characters to a uniform case, standardizing whitespace, and normalizing character encodings.

The server replaces sequences of multiple spaces with a single space, removes control characters, and ensures that line breaks follow a unified representation.

The server outputs normalized passage and learner_answer strings which are used as inputs for tokenization.

### Step 5

The server performs tokenization and removal of unnecessary words.

The server takes the normalized passage and learner_answer strings as input and applies a tokenization procedure that splits each string into a sequence of word tokens based on language-dependent rules.

The server loads a stop-word list into memory, compares each token against the list, and removes tokens that match entries in the list.

The server constructs token arrays for the passage and for the learner_answer, each token annotated with its position index, and the server outputs these cleaned token arrays as analysis data structures.

### Step 6

The server conducts syntactic analysis and feature extraction.

The server takes the normalized passage text and the passage token array as input and applies a syntactic parser to produce a representation of sentences, part-of-speech tags, and dependency relations.

The server traverses the resulting parse structures to calculate syntactic features such as the number of clauses per sentence, the depth of dependency trees, and the distribution of part-of-speech tags.

The server also computes statistical features including total token count, unique token count, type-token ratio, and average sentence length from the token array.

The server aggregates these syntactic and statistical values into a feature vector and outputs the feature vector along with the original passage reference.

### Step 7

The server computes a difficulty index for the passage.

The server takes the feature vector as input and applies a difficulty estimation algorithm, which may be implemented as a trained regression model or a rule-based scoring function.

The server performs numerical operations such as weighted summations, non-linear transformations, or decision-tree evaluations to map the feature vector to a scalar difficulty score.

The server normalizes the score into a predefined range, for example 0 to 100, and outputs the normalized difficulty index and an associated difficulty level classification.

### Step 8

The server estimates a vocabulary usage level of the learner.

The server takes the learner_answer token array as input and queries a vocabulary level table that associates lexical items with frequency information and proficiency levels.

The server matches each token in the learner_answer against entries in the vocabulary table, counts occurrences by proficiency level, and calculates ratios of intermediate and advanced tokens to total tokens.

The server converts these ratios into a vocabulary usage level value, which may be numeric or categorical, and outputs the vocabulary usage level together with the distribution of token levels for further use.

### Step 9

The server constructs a prompt sentence for comprehension evaluation using a generative AI model.

The server takes as input the normalized passage text, the normalized learner_answer text, and optionally the difficulty index and vocabulary usage level.

The server inserts these values into a predefined template to form a natural language instruction string that specifies the evaluation task and desired outputs.

For example, the server may generate a prompt sentence:

“You are an educational assessment assistant. Given the passage and the student's answer below, (1) rate the student's comprehension on a scale from 0 to 100, and (2) provide brief feedback for improvement. Passage: [PASSAGE_TEXT]. Student answer: [ANSWER_TEXT]. Return: comprehension score and feedback.”

The server replaces [PASSAGE_TEXT] and [ANSWER_TEXT] with the actual passage and learner_answer texts and outputs the completed prompt sentence.

### Step 10

The server submits the prompt sentence to the generative AI model and obtains evaluation information.

The server takes the completed prompt sentence as input and encodes it into token identifiers using a tokenizer associated with the generative AI model.

The server passes the token sequence and hyperparameters such as temperature and maximum output length to a model inference engine, which executes neural network computations to generate an output text sequence.

The server decodes the output tokens into a text string and outputs the generated evaluation text, which is expected to contain at least a comprehension score and feedback according to the instructions in the prompt sentence.

### Step 11

The server parses the generative AI model output to extract structured comprehension data.

The server takes the generated evaluation text as input and applies deterministic parsing rules or pattern matching to identify numerical values and feedback segments.

The server locates a comprehension score by searching for patterns such as “score: X” or “X/100” and converts the extracted substring into a numeric value.

The server extracts feedback sentences following designated keywords or separators and trims extraneous content.

The server outputs a structured evaluation object containing at least a numeric comprehension score and a feedback string.

### Step 12

The server integrates difficulty, comprehension, and vocabulary information.

The server takes as input the difficulty index, the comprehension score, the vocabulary usage level, and associated learner identifiers.

The server combines these values into a unified learner profile representation, for example a record with fields for difficulty index, comprehension level, vocabulary level, and timestamp.

The server stores this integrated profile in the learning history database and uses it to determine an ability level category for the learner by applying predefined thresholds or classification rules.

The server outputs the ability level along with the integrated profile for subsequent content selection.

### Step 13

The server selects or generates adapted learning content based on the ability level.

The server takes the learner's ability level and the current difficulty index as input and queries a content repository for candidate learning texts and problems whose difficulty indices fall within a target range around the learner's ability level.

The server ranks the candidate content using criteria such as topical relevance, diversity, and prior usage, and selects one or more items as next learning content.

The server may optionally use another prompt sentence to a generative AI model to transform or augment selected texts, for example by simplifying or elaborating them while preserving difficulty constraints.

The server outputs presentation information containing the selected learning text or problem and associated metadata.

### Step 14

The server generates interactive questions and explanatory texts when appropriate.

The server takes as input the comprehension score, the difficulty index, and the passage text.

When the comprehension score lies within a predetermined range, the server composes a second prompt sentence requesting follow-up questions or explanations.

For example, the server may generate:

“Based on the following passage and the student's current comprehension, create two follow-up questions that target the student's weak points and one short explanatory text. Passage: [PASSAGE_TEXT]. Student comprehension score: [COMPREHENSION_SCORE].”

The server replaces placeholders with actual values, sends this prompt sentence to the generative AI model, receives generated questions and explanations, and parses them into a structured set of interactive items.

The server outputs an extended presentation object that includes these interactive questions and explanatory texts.

### Step 15

The server sends evaluation results and learning content to the terminal.

The server takes the integrated learner profile, selected learning content, interactive questions, and explanatory texts as input and packages them into a response payload with clearly defined fields.

The server serializes this payload and transmits it to the terminal over the network using the same secure protocol.

The server outputs a complete response message containing both numerical evaluation data and human-readable content.

### Step 16

The terminal presents the received information to the user and learner.

The terminal takes the response payload from the server as input and deserializes it to obtain evaluation scores, feedback, learning texts, problems, and interactive questions.

The terminal updates its user interface by rendering the text passage, displaying scores such as the difficulty index and comprehension score, and showing feedback and follow-up questions in designated interface components.

The terminal outputs a visual display that allows the user and the learner to review results and interact with the new questions.

### Step 17

The user interacts with updated content and may trigger another analysis cycle.

The user views the displayed evaluation results and learning content on the terminal and instructs the learner to respond to interactive questions or new problems.

The terminal records the new learner answers as input and packages them into another structured data object, including references to the current analysis identifier and content identifiers.

The terminal outputs a new request payload and transmits it to the server, thereby initiating another iteration of the processing flow with updated learning history information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems suffer from several technical limitations in how they process and adapt natural-language content. In many systems, a processing device merely retrieves pre-authored texts and fixed questions according to coarse difficulty labels, without deeply analyzing linguistic features of the texts or the learner's responses. Such systems typically do not construct machine-interpretable indices that quantitatively represent vocabulary difficulty and comprehension difficulty, and therefore cannot perform fine-grained control over the selection, generation, and rewriting of learning content.

Furthermore, known systems that employ generative AI models often use such models in an isolated manner. That is, a generative AI model may generate prompt sentences or questions based only on generic instructions, without being tightly integrated with a pipeline that (i) performs systematic natural language analysis of both source texts and generated outputs, (ii) computes structured indices of difficulty, and (iii) closes the loop by updating a learner model and automatically tuning subsequent model inputs. As a result, the difficulty of machine-generated prompt sentences and rewritten texts can fluctuate unpredictably, and the system cannot reliably converge the difficulty of the content to a desired target range.

From a computer technology standpoint, there is also an inefficiency in how many existing systems manage learning history and progress. Some systems simply log events and scores at an application level, without structuring such data as machine-usable progress information that can directly drive content selection algorithms. This leads to redundant server-side processing, repeated analysis of similar data, and suboptimal use of computational resources. Moreover, conventional architectures frequently separate natural language processing components from generative components, preventing the processor from using unified difficulty indices and progress data across all stages of analysis, generation, rewriting, and evaluation.

Accordingly, there is a need for an improved computer-implemented system in which a processor (i) performs integrated natural language processing on learner data and learning texts to compute quantitative vocabulary and comprehension indices, (ii) uses these indices as control parameters in searching storage devices for suitable texts, in generating prompt sentences via a generative AI model, and in rewriting texts to match a target difficulty band, and (iii) continuously updates the indices and learning progress information based on correctness determination and semantic similarity analysis of learner responses. Such a system should improve the technical functioning of the learning support platform itself, by reducing mismatches in content difficulty, avoiding unnecessary model calls and recomputation, and enabling a more stable, closed-loop control of content difficulty through coordinated analysis and generation on the server side.

The specific processing by the specific processing unit 290 of the data processing device 12 in Application Example 1 is realized by the following means.

The present invention provides a server comprising a processor and one or more storage devices, the processor being configured to execute machine-implemented operations including: acquiring, from the storage devices, response information and behavior information of a learner; analyzing linguistic feature information and structural feature information of learning target text including the response information and the behavior information by using a natural language processing function implemented on the server; calculating, as numerical values, a vocabulary index and a comprehension index for the learner based on a result of the analysis; searching, by using the vocabulary index and the comprehension index, the storage devices in which a plurality of learning texts are stored together with difficulty information; selecting a learning text suitable for the learner based on a relationship between the difficulty information and the vocabulary index and the comprehension index; distributing the selected learning text to a terminal device via a communication interface; generating input text including the vocabulary index, the comprehension index, summary information relating to the selected learning text, and learning purpose information; inputting the input text to a generative information processing model as a generative AI model to cause the generative information processing model to generate a prompt sentence corresponding to the selected learning text; evaluating expression difficulty of the generated prompt sentence by the natural language processing function; distributing, to the terminal device, a prompt sentence whose evaluation result falls within a predetermined range; generating, based on a difference between the vocabulary index and the comprehension index and the difficulty information of the selected learning text, rewrite instruction text that instructs the generative information processing model to generate a rewritten version of the selected learning text while maintaining semantic content of the selected learning text and causing vocabulary difficulty and syntactic difficulty to converge to a target range; inputting the rewrite instruction text to the generative information processing model to cause the generative information processing model to generate a difficulty-adjusted learning text; re-evaluating, by the natural language processing function, difficulty of the difficulty-adjusted learning text; distributing the difficulty-adjusted learning text to the terminal device in a case where a result of the re-evaluation falls within the target range; executing correctness determination processing and semantic similarity calculation processing based on input responses, reaction time information, and operation history information of the learner acquired from the terminal device; updating the vocabulary index and the comprehension index according to results of the correctness determination processing and the semantic similarity calculation processing; storing the updated vocabulary index and the updated comprehension index in the storage devices as learning history; and automatically changing difficulty of a subsequent learning text and a subsequent prompt sentence to be provided in a following learning session based on the learning history. This enables an integrated server-side control loop in which the processor quantitatively models learner vocabulary and comprehension, orchestrates natural language analysis and generative AI model operations under explicit difficulty constraints, and dynamically adapts both retrieved and generated textual content, thereby improving the technical performance, stability, and efficiency of the computer-implemented learning support system.

The term “learner” refers to a human user who interacts with the system to receive learning content, provide responses, and whose abilities are evaluated by the processor.

The term “processor” refers to one or more hardware processing units, such as a central processing unit or a graphics processing unit, configured to execute program instructions to perform the operations described in the claims.

The term “storage device” refers to a non-transitory computer-readable medium, such as a semiconductor memory, magnetic storage, or optical storage, configured to store data, models, indices, and program instructions used by the processor.

The term “response information” refers to digital data representing answers, textual inputs, selections, or other explicit outputs provided by the learner in reaction to learning content or questions presented by the system.

The term “behavior information” refers to digital data representing interaction patterns of the learner, including operation logs, navigation actions, and temporal information related to the learner's use of the system.

The term “learning target text” refers to natural-language text data that is used by the system as subject matter for analysis, evaluation of the learner, and presentation as part of learning content.

The term “linguistic feature information” refers to information derived from the learning target text by natural language analysis, including tokenization, lexical forms, parts of speech, and word frequency characteristics.

The term “structural feature information” refers to information representing structural aspects of the learning target text, including sentence lengths, clause structures, syntactic dependency relations, and other indicators of textual complexity.

The term “natural language processing function” refers to program modules executed by the processor that perform automatic analysis, transformation, or evaluation of human language text, including tokenization, parsing, and difficulty estimation.

The term “vocabulary index” refers to a numerical value computed by the processor that quantitatively represents a level of vocabulary difficulty or vocabulary ability associated with a learner or text.

The term “comprehension index” refers to a numerical value computed by the processor that quantitatively represents a level of comprehension ability or comprehension difficulty associated with a learner or text.

The term “information storage device” refers to a storage device configured to maintain structured data including learning texts, difficulty information, learner history, and other records used by the system.

The term “learning text” refers to natural-language text selected, generated, or rewritten by the system for presentation to the learner as part of a learning session.

The term “difficulty information” refers to metadata indicating difficulty characteristics of a learning text, including vocabulary difficulty, syntactic complexity, or composite difficulty scores.

The term “terminal device” refers to an electronic device operated by the learner, such as a client computer or mobile terminal, configured to communicate with the server and present learning content and prompt sentences.

The term “summary information” refers to text data that concisely describes the main content or theme of a learning text and is used as part of input to the generative information processing model.

The term “learning purpose information” refers to data indicating an instructional goal or objective, such as checking understanding of a main idea or practicing summarization, used to control generation of content.

The term “generative information processing model” refers to a trained machine learning model that receives input text and generates output text, such as prompt sentences, rewritten texts, questions, or instructions, based on probabilistic or neural network-based computation.

The term “generative AI model” refers to a generative information processing model implemented using artificial intelligence techniques, such as deep learning, configured to generate natural-language text in response to input conditions.

The term “prompt sentence” refers to a natural-language sentence generated or selected by the system and presented to the learner to elicit a response, explanation, or other learning activity with respect to a learning text.

The term “expression difficulty” refers to a measure of linguistic complexity of a prompt sentence or other text, including vocabulary difficulty and syntactic complexity, as evaluated by the natural language processing function.

The term “rewrite instruction text” refers to input text generated by the processor that instructs the generative information processing model to produce a rewritten version of a learning text according to specified difficulty constraints.

The term “difficulty-adjusted learning text” refers to a learning text that has been generated or rewritten so that its vocabulary difficulty and syntactic difficulty fit within a predefined target range.

The term “target range” refers to a predetermined or dynamically computed interval of difficulty values, such as vocabulary difficulty or syntactic difficulty levels, used by the system as a control objective for content adaptation.

The term “correctness determination processing” refers to processing performed by the processor to determine whether a learner's response is correct or incorrect by comparing the response with reference information.

The term “semantic similarity calculation processing” refers to processing performed by the processor to compute a similarity measure between a learner's free-text response and a reference text based on semantic features.

The term “learning history” refers to stored data that records past interactions of the learner with the system, including indices, responses, scores, and content identifiers, used to adapt future learning content.

The term “learning situation” refers to a state or context of the learner's ongoing learning, including current difficulty level, recent performance, and progress within a sequence of learning texts.

The term “interactive question information” refers to data defining questions that require active input from the learner, such as multiple-choice questions or open-ended questions, and that are presented through the terminal device.

The term “problem information” refers to data defining tasks or exercises provided to the learner, including question statements, answer formats, and associated metadata.

The term “description information indicating the learning text” refers to metadata or textual descriptors that identify or summarize a learning text for use as input to the generative information processing model.

The term “question sentence” refers to a natural-language sentence that poses a question or task to the learner and is generated or selected by the system.

The term “option sentence” refers to a natural-language sentence representing one candidate answer in a multiple-choice or similar question format.

The term “descriptive answer instruction sentence” refers to a natural-language sentence instructing the learner to provide a free-text or descriptive response.

The term “content suitability” refers to a degree to which a generated question, prompt, or text is appropriate in terms of topic, relevance, and learning objective for the corresponding learning text and learner state.

The term “learning session” refers to a unit of interaction between the learner and the system over a period of time, during which one or more learning texts, questions, or prompt sentences are presented and responses are collected.

The term “progress information” refers to recorded data representing temporal and performance aspects of a learning session, including times, viewed content, responses, and associated indices.

The term “viewed text identification information” refers to data identifying a learning text that has been displayed or accessed by the learner during a learning session.

The term “answer result information” refers to data indicating outcomes of learner responses, including correctness, scores, or qualitative evaluations.

The term “recommended difficulty band” refers to a range of difficulty levels estimated by the processor as suitable for future content for a particular learner based on progress information.

The term “recommended learning field” refers to a category or domain of learning, such as subject matter or topic area, estimated by the processor as suitable for future learning texts for a particular learner.

The term “generation conditions of the prompt sentence” refers to parameters or constraints, including target difficulty and instructional goal, used by the processor when preparing input for the generative information processing model to generate a prompt sentence.

In one embodiment, a server cooperates with a terminal and a user to realize an adaptive learning support system that analyzes natural-language text, evaluates a learner's vocabulary and comprehension, and generates or rewrites content using a generative AI model. The server is implemented by one or more hardware processors, such as central processing units and optionally graphics processing units, connected to main memory, persistent storage devices, and a network interface. The server executes programs stored on non-transitory computer-readable media. The terminal is implemented by a client device, such as a mobile terminal or a personal computer, equipped with a display unit, an input unit, local memory, and a communication interface. The user operates the terminal.

The server executes an operating system such as a general-purpose server operating system and executes application software written, for example, in a programming language such as Python or another high-level language. The server uses a natural language processing library, for example a dependency-parsing library implemented in a language processing framework, and a machine learning framework, for example a tensor-based numerical computation library. The server implements a generative AI model as a neural network, such as a Transformer-based sequence-to-sequence model, which is either deployed locally on the server or accessed via a remote model-serving endpoint. The server also uses a relational database management system such as a generic SQL-compatible database to store learner data, text data, indices, and model configuration parameters.

The server maintains structured data in the storage device using specific data structures. The server stores learning texts and associated difficulty information in a content table, for example with fields including: text identifier, raw text, vocabulary difficulty score, structural complexity score, and topic labels. The server stores learner information in a learner profile table, including learner identifier, current vocabulary index, current comprehension index, and accumulated statistics such as average accuracy and average response time. The server stores interaction logs and progress information in a progress table, including session identifier, start time, end time, list of viewed text identifiers, answer result information, and index values at the time of each session. By designing these data structures explicitly with indexed columns and normalized relationships, the server reduces data redundancy and enables efficient query execution, which contributes to reduced processing time and reduced memory usage when adapting content.

The server executes a natural language processing function using the language processing library. The server loads a pre-trained language model, such as an English-language model that provides tokenization, part-of-speech tagging, lemmatization, and dependency parsing. The server processes each learning text and each learner response to obtain token sequences, sentence boundaries, dependency trees, and part-of-speech tags. The server computes linguistic feature vectors for each text, including features such as token count, type-token ratio, proportion of low-frequency lexical items, mean sentence length, and maximum dependency tree depth. The server stores these feature vectors in the database, for example in a separate analysis table, and uses them as inputs for calculating the vocabulary index and comprehension index.

The server calculates the vocabulary index by combining linguistic feature values of the learning text with statistics derived from the learner's responses. The server compares the lemmas of the learning text to a graded vocabulary list stored in the database, for example a list assigning each lemma to one of multiple difficulty levels. The server computes the ratio of high-level lemmas to all lemmas and uses this ratio, together with sentence-length statistics and error rates in learner answers, as input features to a predictive model. The server implements this predictive model using a neural network provided by the machine learning framework. For example, the server constructs a feed-forward network with an input layer receiving a feature vector, one or more hidden layers with non-linear activation functions such as rectified linear units, and an output layer producing a scalar vocabulary index. The server trains this network offline using historical learner data and a loss function such as mean squared error between predicted indices and reference indices. During operation, the server loads the trained network parameters into memory and performs feed-forward computation on the feature vector to output the vocabulary index.

The server similarly calculates the comprehension index by using features related to correctness of answers, semantic similarity between learner responses and reference answers, and response time distributions. The server represents each learner free-text answer as an embedding vector using an embedding model, for example a sentence embedding model implemented as a Transformer encoder or a bidirectional recurrent neural network. The server calculates a cosine similarity between the learner embedding and a reference answer embedding. The server uses this similarity, along with binary correctness indicators for structured questions and normalized response times, as input to a second predictive model implemented using the machine learning framework. The server minimizes, during offline training, a loss function combining squared error and possibly regularization terms to stabilize the parameters. During operation, the server computes the comprehension index by executing forward propagation with the trained weights.

The server uses the vocabulary index and comprehension index as control parameters for content selection. The server executes SQL queries that filter the content table by difficulty information, where the difficulty information includes vocabulary difficulty and structural complexity scores precomputed for each learning text. The server calculates a target band around the learner's indices, for example by defining a range centered on the learner's vocabulary index with a predetermined width. The server retrieves learning texts whose stored difficulty scores fall into this target band. The server ranks candidate texts using additional factors, such as topic diversity or exposure count, to avoid repeatedly selecting the same text. By maintaining this structured selection algorithm, the server reduces the number of texts that must be examined and avoids unnecessary processing of texts that are clearly out of range, thereby improving computational efficiency and reducing database load.

The server generates a prompt sentence by creating a structured input sequence for the generative AI model. The server creates an input string that encodes the learner's vocabulary index, the comprehension index, a summary of the selected learning text, and learning purpose information. The server can, for example, generate the following prompt as control text for the generative AI model:

“The student's vocabulary score is 45 out of 100. The student will read a short passage from a fantasy story about a boy entering a magic school. Generate one simple English prompt sentence that asks the student to explain the main idea of the passage.”

The server inputs this control text to the generative AI model, which is implemented as a Transformer-based language model. The server executes the model either locally or via remote inference. The server sets explicit parameters such as maximum output length, temperature, and top-k or top-p sampling thresholds, which control diversity and stability of the generated output. The server receives the generated text and extracts the prompt sentence. The server then evaluates the expression difficulty of this prompt sentence by applying the same natural language processing function. The server calculates, for example, the proportion of high-level words and the mean sentence length, and compares these values against a target difficulty band aligned with the learner's vocabulary index. If the difficulty is outside the range, the server adjusts the control text, for example by adding stronger constraints such as “Use only very common words and short sentences,” and re-invokes the generative AI model. By imposing this closed-loop control with explicit metrics and constraints, the server prevents uncontrolled variation of difficulty and reduces the number of unsuitable outputs, thereby improving both accuracy and efficiency of model usage.

The server also rewrites learning texts dynamically. The server compares the stored difficulty information of a learning text with the learner's indices. If the difference exceeds a threshold, the server constructs rewrite instruction text including both the original text and target difficulty constraints. For example, the server may construct an instruction such as:

“Rewrite the following passage so that it is suitable for a student with vocabulary score 40 out of 100. Use common words and short sentences. Keep the meaning the same. Passage: [original text].”

The server inputs this instruction to the generative AI model. The model generates a rewritten version of the learning text. The server performs natural language processing on the rewritten text and recalculates difficulty scores. If the scores are within the target band, the server stores the rewritten text as a difficulty-adjusted learning text associated with the learner and delivers it to the terminal. If the scores are still outside the target band, the server can adjust parameters or modify the constraints and request another rewrite. This iterative, metric-driven rewriting process goes beyond simple human editing or static simplification; the server uses explicit quantitative feedback to converge towards a desired complexity, thereby improving the precision of difficulty control and minimizing manual intervention.

The terminal displays the selected or rewritten learning text and the prompt sentence to the user. The terminal executes a client application, which may be implemented as a native application or a web application running in a browser. The terminal receives structured data from the server, such as JSON objects containing text identifiers, text bodies, prompt sentences, and metadata. The terminal parses this data and renders the text and prompt in an interface that allows the user to read and respond. For example, when the user is reading a passage inspired by a fantasy novel, the terminal may display the following prompt sentence received from the server:

“Read the passage and explain the main theme in your own simple words.”

The user reads the passage and enters a textual response through an input field on the terminal. The terminal records the response, the time at which the response was submitted, and the time spent on the passage. The terminal transmits this information to the server.

The server receives the learner's response and executes correctness determination processing and semantic similarity calculation processing. For multiple-choice or structured questions, the server compares the learner's selection with a reference answer stored in the database. For open-ended prompts, the server embeds the learner's response and the reference answer into a vector space using the embedding model. The server calculates cosine similarity and may apply thresholds or non-linear scoring functions to derive a quality score. The server uses these scores, together with response time statistics, to update the vocabulary index and comprehension index by executing forward propagation in the predictive models. The server writes updated indices and related progress information to the storage device. Because the server uses structured embeddings and quantitative thresholds instead of relying solely on rule-based string matching, the server can evaluate semantically diverse responses more robustly, which increases the accuracy and consistency of scoring.

The server then uses the updated indices to drive subsequent content selection and generation. By feeding fresh, quantitative measurements back into the selection and generation modules, the server implements a closed-loop adaptation mechanism. This mechanism reduces the number of unsuitable texts selected for a given learner and lowers the rate of mismatch between learner ability and content difficulty. Consequently, the server reduces unnecessary network traffic and computational load, since fewer retries and fewer supplemental explanations are needed. The server manages resource usage by, for instance, limiting calls to the generative AI model when existing repository texts already match the target difficulty, and only invoking rewriting when a significant mismatch is detected.

In another embodiment, the server configures the generative AI model with a specific neural architecture. The server uses a Transformer architecture with multiple encoder and decoder layers, multi-head self-attention modules, and position-wise feed-forward networks. The server trains the model on paired data consisting of instructions and target outputs, such as instructions about generating prompt sentences and corresponding model outputs. The server minimizes a cross-entropy loss between predicted tokens and reference tokens using gradient-based optimization methods such as Adam. The server updates network weights in mini-batches and may use techniques such as learning-rate scheduling, dropout regularization, and data augmentation by paraphrasing training instructions. This detailed training process allows the model to generate prompt sentences and rewritten texts that respect difficulty constraints encoded in the instruction text more reliably than a generic language model.

The server can also implement alternative models and data flows. In one variation, the server employs a hybrid rule-based and neural approach. The server first applies deterministic rules to simplify or complicate certain structural features, such as splitting long sentences or replacing complex conjunctions, before invoking the generative AI model for fine-grained paraphrasing. In another variation, the server uses a curriculum-learning strategy for the neural network, training first on simpler text pairs and gradually introducing more complex instructions. These alternatives further improve robustness and stability of the system and demonstrate that the invention is not limited to a single neural configuration.

The server improves computer technology in several ways. The server reduces processing time by precomputing and caching linguistic feature vectors and difficulty scores for texts, thereby avoiding repeated heavy parsing operations. The server reduces computational cost and network traffic by using quantitative difficulty indices to decide when to call the generative AI model and when to reuse existing texts. The server improves the accuracy of difficulty matching by combining multiple feature sources—linguistic features, learner performance, and semantic similarity—into numerical indices that control all major operations of analysis, selection, generation, and rewriting. The server improves data management by storing indices and progress information in normalized relational tables with explicit relationships, which facilitates efficient queries and updates. The server improves overall system stability by coupling natural language processing and generation in a feedback loop that uses explicit metrics rather than ad hoc heuristics.

The user benefits from the system because the server reduces over-challenging or under-challenging content and maintains a consistent difficulty progression. However, from a technical perspective, the primary improvement resides in the way the server structures data, executes numerical algorithms, configures the neural models, and controls communication sequences to achieve efficient and precise content adaptation. The system thus goes beyond merely automating a human tutor's decisions; the server implements computational structures, indices, and feedback algorithms that are not feasible to execute manually, and that provide measurable improvements in latency, accuracy, and resource utilization in a computerized learning environment.

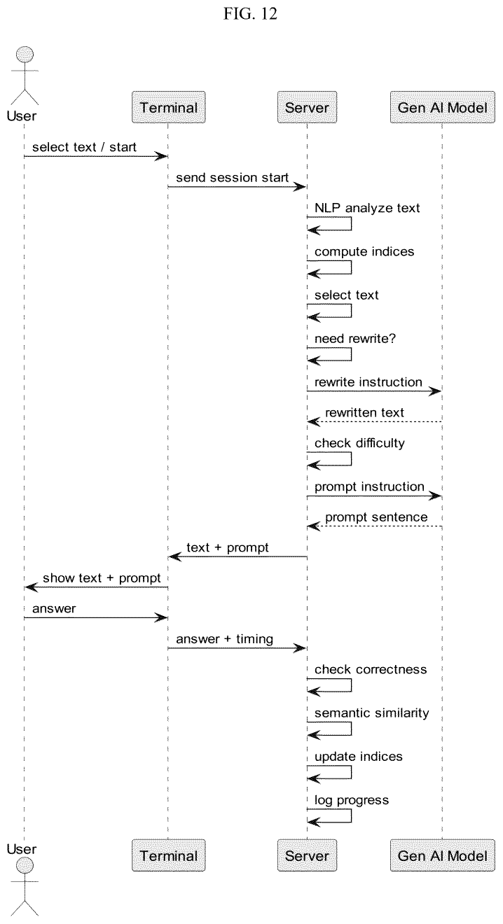

The following describes the processing flow using FIG. 12.

### Step 1

The terminal transmits learner interaction data and content selection data to the server.

The terminal uses an application program to package input data including a learner identifier, selected content identifier, current learning target text, previous answer information, and timestamps into a structured data object, and sends the object to the server over a network.

The terminal serializes the data into a predefined format and ensures that the encoding and required fields are valid before transmission.

The output of Step 1 is a data message containing learner-related input and text-related input delivered from the terminal to the server.

### Step 2

The server receives the learner interaction data and content selection data from the terminal and performs initial validation.

The input of Step 2 is the data message received over the network from the terminal.

The server parses the data message, verifies field consistency (for example, checking that required identifiers are present and that text fields are non-empty), and stores raw copies of the received learner responses, learning target text, and associated metadata into a storage device.

The server outputs validated and stored records including a learner record and a text record that are ready for linguistic analysis.

### Step 3

The server executes natural language preprocessing on the learning target text and, when applicable, on learner free-text responses.

The input of Step 3 is the stored learning target text and optional learner response text.

The server uses a natural language processing library to perform operations including sentence segmentation, tokenization, part-of-speech tagging, lemmatization, and dependency parsing. The server converts the raw text into structured data, such as token lists, sentence boundaries, and parse trees.

The output of Step 3 is a set of linguistic feature structures for the learning target text and the learner response text, including token-level annotations and syntactic information.

### Step 4

The server computes linguistic feature values and structural complexity values from the parsed text.

The input of Step 4 is the linguistic feature structures generated in Step 3.

The server calculates numeric values including token counts, type-token ratio, proportion of low-frequency words, average sentence length, maximum sentence length, and average dependency tree depth. The server may also compute additional statistics such as ratio of subordinate clauses or use of advanced grammatical constructions.

The output of Step 4 is a numeric feature vector representing vocabulary-related features and structure-related features for the analyzed text.

### Step 5

The server calculates a vocabulary index and a comprehension index for the learner using the computed features and historical performance data.

The input of Step 5 is the numeric feature vector from Step 4 and learner performance data retrieved from the storage device, including past correctness rates, previous indices, and response times.

The server feeds these inputs into predictive models implemented in a machine learning framework, such as a feed-forward neural network for vocabulary index and another predictive model for comprehension index. The server executes matrix multiplications and non-linear activation functions to transform the input feature vector into scalar index values. The server may apply normalization or smoothing to stabilize changes between sessions.

The output of Step 5 is an updated vocabulary index and an updated comprehension index associated with the learner.

### Step 6

The server stores the updated indices and session context as learning history.

The input of Step 6 is the updated vocabulary index, the updated comprehension index, and session metadata including time, text identifier, and response results.

The server writes a new record into a progress table in the storage device, associating the indices with the learner identifier and the text identifier, and updates the learner profile record with the most recent index values. The server may also update derived values such as moving averages or difficulty band recommendations.

The output of Step 6 is a persistent learning history entry and an updated learner profile that can be used in later steps.

### Step 7

The server selects candidate learning texts from the storage device according to the learner's indices.

The input of Step 7 is the vocabulary index, the comprehension index, and a repository of learning texts with precomputed difficulty information.

The server computes a target difficulty range around the learner's indices and issues structured queries to the content table to retrieve only those learning texts whose vocabulary difficulty and structural complexity fall within or close to the target range. The server may also filter by topic or by whether the learner has previously viewed the text.

The output of Step 7 is a list of candidate learning texts and their associated difficulty metadata.

### Step 8

The server ranks and selects a final learning text from the candidate list.

The input of Step 8 is the set of candidate learning texts from Step 7 and optionally learner preferences or coverage history.

The server computes a ranking score for each candidate based on criteria such as closeness of difficulty to the target, topic diversity, recency of use, and coverage of learning objectives.

The server sorts the candidates by score and selects the top-ranked text as the next learning text for the learner.

The output of Step 8 is a selected learning text and its difficulty information to be used in subsequent operations.

### Step 9

The server evaluates whether difficulty adjustment of the selected learning text is necessary.

The input of Step 9 is the selected learning text and its difficulty information, along with the learner's vocabulary index and comprehension index.

The server computes a difference measure between the text difficulty values and the learner's indices. If the difference exceeds predefined thresholds for vocabulary difficulty or structural complexity, the server sets a flag indicating that rewriting is required. Otherwise, the server retains the original text for delivery.

The output of Step 9 is a decision value indicating “no rewriting required” or “rewriting required” and, in the latter case, target difficulty constraints for rewriting.

### Step 10

The server generates rewrite instruction text for the generative AI model when difficulty adjustment is required.

The input of Step 10 is the original learning text, the learner's vocabulary index and comprehension index, and the target difficulty constraints determined in Step 9.

The server constructs a control instruction that includes the original text and explicit requirements, such as target vocabulary level, maximum sentence length, and requirement to preserve semantic content. The server concatenates these elements into a single instruction string understandable by the generative AI model.

The output of Step 10 is a rewrite instruction text to be submitted to the generative AI model.

### Step 11

The server generates a difficulty-adjusted learning text using the generative AI model.

The input of Step 11 is the rewrite instruction text produced in Step 10.

The server sends this instruction to the generative AI model, implemented for example as a Transformer-based sequence-to-sequence model, and configures generation parameters such as maximum output length, temperature, and sampling parameters. The server receives the generated text from the model, treating it as a candidate difficulty-adjusted learning text.

The output of Step 11 is a candidate difficulty-adjusted learning text.

### Step 12

The server verifies the difficulty of the candidate difficulty-adjusted learning text and finalizes the text version.

The input of Step 12 is the candidate difficulty-adjusted learning text produced in Step 11.

The server performs natural language preprocessing and feature computation as in Steps 3 and 4 for this new text, and then calculates updated difficulty measures. The server compares these measures to the target difficulty constraints. If the measures fall within the target range, the server accepts the candidate text as the finalized difficulty-adjusted learning text. If the measures fall outside the target range, the server may adjust rewriting parameters and repeat Steps 10 and 11, or fall back to an alternative learning text.

The output of Step 12 is a finalized learning text, which may be either the original or the difficulty-adjusted version, prepared for presentation.

### Step 13

The server prepares input for the generative AI model to generate a prompt sentence aligned with the learner's indices and the selected learning text.

The input of Step 13 is the finalized learning text, the vocabulary index, the comprehension index, and learning purpose information (for example, “check understanding of main idea”).

The server extracts or generates a short summary of the learning text and encodes the indices and learning purpose into a structured instruction string. The server may create a control prompt such as: “The student's vocabulary score is 45 out of 100. The student will read a passage. Generate one simple English prompt sentence that asks the student to explain the main idea.”

The output of Step 13 is a prompt-generation instruction text for the generative AI model.

### Step 14

The server generates a prompt sentence using the generative AI model and evaluates its difficulty.

The input of Step 14 is the prompt-generation instruction text produced in Step 13.

The server sends this text to the generative AI model with specific decoding parameters and receives an output string representing a candidate prompt sentence. The server then executes natural language processing on this prompt sentence to compute vocabulary difficulty and structural simplicity, and compares these measurements with a target band linked to the learner's vocabulary index. If the difficulty is too high or too low, the server refines the instruction text with stronger constraints and regenerates the prompt sentence.

The output of Step 14 is a finalized prompt sentence whose difficulty is acceptable for the learner.

### Step 15

The server transmits the finalized learning text and the finalized prompt sentence to the terminal.

The input of Step 15 is the finalized learning text, the finalized prompt sentence, and associated metadata such as identifiers and difficulty values.

The server packages this information into a structured response, attaches session identifiers, and sends the response to the terminal through the communication interface. The server may also log that this specific text and prompt were delivered for tracking purposes.

The output of Step 15 is a delivery message containing the learning text and the prompt sentence sent from the server to the terminal.

### Step 16

The terminal receives the learning content and renders it to the user.

The input of Step 16 is the delivery message sent from the server in Step 15.

The terminal parses the received data, extracts the learning text and prompt sentence, and displays them on a screen in a learning interface. The terminal may format the text with appropriate fonts, line breaks, and navigation controls, and position the prompt sentence near an input field for the user's answer.

The output of Step 16 is a visual representation of the learning text and prompt sentence on the terminal's display.

### Step 17

The user reads the displayed learning text and responds to the prompt sentence.

The input of Step 17 is the rendered learning text and the prompt sentence displayed by the terminal.

The user reads the content, interprets the prompt, and enters a response by typing text or selecting options through the terminal's input interface. The user's response may include free-text explanations, multiple-choice selections, or other interactive inputs.

The output of Step 17 is a set of raw user response data held temporarily within the terminal.

### Step 18

The terminal records the user's response, reaction time, and interaction events, and sends them back to the server.

The input of Step 18 is the user's raw response, the timestamps when the text was shown and when the response was submitted, and any relevant interaction logs such as scrolling or pausing actions.

The terminal compiles these into a structured record, including the learner identifier, session identifier, text identifier, prompt identifier, answer content, correctness indicators if locally available, and timing data. The terminal transmits this record to the server over the network.

The output of Step 18 is an interaction record message that describes the user's behavior and responses in the completed learning session.

### Step 19

The server evaluates the user's responses and updates indices for continuous adaptation.

The input of Step 19 is the interaction record message from Step 18, along with reference answers, previous indices, and any stored embedding representations.

The server applies rule-based checks for structured questions, computes semantic similarity between free-text responses and reference answers using an embedding model, and calculates correctness scores and quality scores. The server then recomputes or adjusts the vocabulary index and comprehension index by applying the predictive models with new feature values, such as updated correctness rates and response times. The server stores the new indices and updated progress information in the storage device.

The output of Step 19 is an updated learner profile and an extended learning history, which will be used as input for the next execution of Steps 7 and onward in subsequent learning sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning support systems that deliver electronic teaching materials typically adjust difficulty using coarse rules, such as grade level or a fixed proficiency band. In many such systems, a server merely retrieves content tagged with a static level and pushes it to a learner terminal, without deeply analyzing the learner's actual language use or response behavior. As a result, the server often fails to match the difficulty of textual content to the learner's true vocabulary ability and comprehension ability, leading to under-challenging or over-challenging materials and inefficient use of computing resources devoted to content delivery.

In addition, in many existing architectures, natural language generation components are invoked with manually authored, generic prompts, or with simple parameter settings such as “intermediate level” or “beginner level.” These prompts do not systematically incorporate fine-grained statistics derived from the learner's historical answers and behavioral logs, such as vocabulary frequency distributions, vocabulary diversity, and difficulty-based accuracy. This causes the generative AI model to operate in a largely content-agnostic manner, wasting computational capacity and network bandwidth by generating content that is not tightly aligned with the learner's evolving state, and requiring additional manual tuning by instructors or operators.

Further, some known systems log learner responses and operation histories in a storage device, but treat these logs primarily as passive records for later human review. The logs are not actively recycled as machine-usable training signals to dynamically adjust prompts or difficulty parameters for subsequent content generation. Consequently, the server cannot automatically close the loop between learner performance, content generation, and future adaptation, which prevents the system from achieving a self-optimizing behavior and leads to suboptimal utilization of computation, memory, and network resources in the learning pipeline.

Moreover, although interactive quizzes and comprehension-check questions are sometimes generated or selected, such functions are often implemented by separate tools or static question banks. These tools are not integrated with the same generative AI model and do not share the same prompt-generation logic or difficulty control parameters. This fragmentation causes inconsistencies between explanatory content and assessment content, requires redundant processing, and complicates server-side software architecture, resulting in higher processing overhead and reduced maintainability.

There is therefore a need for a server-centric technical framework that: (i) automatically derives precise vocabulary and comprehension metrics from learner logs using natural language processing and statistical processing; (ii) programmatically constructs prompt sentences for a generative AI model in a way that encodes those metrics, difficulty constraints, and content-length constraints; (iii) utilizes the generative AI model both for explanation generation and assessment generation in a unified workflow; and (iv) continuously updates the prompt parameters and thus the generated learning content based on cumulative learning history and progress indices. By doing so, the computer system can more efficiently allocate processing resources, reduce manual intervention, and improve the technical performance and adaptability of the content generation pipeline.

The specific processing by the specific processing unit 290 of the data processing device 12 in Example 2 is realized by the following means.

The present invention provides a server comprising a processor configured to acquire, from an information storage device and based on identification information of a learning subject and request information regarding a learning field, response history information and behavioral history information of the learning subject; to preprocess acquired text information and correctness information by using natural language processing technology and statistical processing technology so as to calculate word occurrence frequency, vocabulary diversity, and vocabulary difficulty indices and thereby numerically evaluate a vocabulary ability level and a comprehension ability level of the learning subject; to automatically generate a prompt sentence, which is an instruction sentence to be input to a generative AI model, on the basis of an evaluation result and the request information regarding the learning field by using a predefined sentence template and character string processing; to transmit the prompt sentence to the generative AI model and obtain, from the generative AI model by natural language generation processing, explanation text and learning content having a difficulty level corresponding to the evaluation result; to convert the obtained explanation text and learning content into a data structure transmittable to an output device and distribute the data structure to an information processing terminal for the learning subject; to append response result information and operation history information of the learning subject to the information storage device and reflect appended information in subsequent evaluations and subsequent automatic generation of the prompt sentence; to additionally generate, based on explanation text obtained from the generative AI model, a prompt sentence for generating interactive problem information including comprehension-check questions and options, and input the prompt sentence to the generative AI model so as to generate problem content including a plurality of questions and correct answer information; and to calculate a learning progress index on the basis of learning history information stored in the information storage device and automatically change difficulty designation information and amount designation information in the prompt sentence in accordance with the learning progress index and the vocabulary ability level and the comprehension ability level, thereby continuously updating the learning content obtained from the generative AI model. This enables the server to implement, in a single integrated computing architecture, a closed-loop adaptive content generation mechanism in which learner logs are algorithmically transformed into prompt parameters for a generative AI model, so that explanation content and assessment content are automatically tailored in difficulty, volume, and topic to the learner's evolving state, thereby improving the efficiency, responsiveness, and technical performance of computer-based learning support.

The term “learning subject” refers to a human learner who receives educational content and whose response history information and behavioral history information are acquired, analyzed, and used for adaptive content generation.

The term “identification information” refers to information that uniquely or pseudo-uniquely distinguishes one learning subject from other learning subjects within the system, such as an identifier, account code, or login credential.

The term “request information regarding a learning field” refers to information indicating a subject area, topic, or theme for which the learning subject requests educational content, including, for example, a domain such as science, history, or language arts and any subtopic designation.

The term “response history information” refers to information representing past answers, solution attempts, or input texts provided by the learning subject in response to questions, tasks, or prompts issued by the system.

The term “behavioral history information” refers to information representing past operations or interactions performed by the learning subject with respect to the system, including, for example, page transitions, selection operations, input timings, and durations of content viewing.

The term “information storage device” refers to any storage mechanism, such as a memory device or persistent storage subsystem, that stores response history information, behavioral history information, learning history information, and related data used by the server.

The term “text information” refers to character-string data representing natural language content contained in the response history information, including answers, explanations, or other textual inputs from the learning subject.

The term “correctness information” refers to information indicating whether a response of the learning subject is correct or incorrect, or indicating a correctness score, reliability value, or similar performance metric.

The term “natural language processing technology” refers to computer-implemented processing techniques for analyzing and transforming natural language text, including at least tokenization, part-of-speech tagging, lemmatization, filtering, and similar linguistic analyses.

The term “statistical processing technology” refers to computer-implemented methods for calculating numerical values, statistics, or distributions, including frequencies, averages, ratios, and indices derived from response history information and text analysis results.

The term “word occurrence frequency” refers to a numerical value or distribution representing how often individual words or word forms appear in the text information associated with the learning subject.

The term “vocabulary diversity” refers to a numerical indicator representing the variety of distinct words or lemmas used by the learning subject relative to the total number of words, or a similar measure of lexical richness.

The term “vocabulary difficulty index” refers to a numerical value or set of values representing estimated difficulty levels of words used or to be presented, based on, for example, predefined difficulty mappings, word lists, or level scales.

The term “vocabulary ability level” refers to an evaluated level of lexical proficiency of the learning subject, numerically or categorically expressed, derived from the word occurrence frequency, vocabulary diversity, vocabulary difficulty indices, and related analyses.

The term “comprehension ability level” refers to an evaluated level of understanding capability of the learning subject, numerically or categorically expressed, derived from correctness information, behavioral patterns, and related performance indicators.

The term “generative AI model” refers to a machine-implemented language generation mechanism, including a trained neural network model, that produces natural language text in response to input conditions such as a prompt sentence.

The term “prompt sentence” refers to an instruction sentence or instruction data structure provided as input to the generative AI model, specifying requirements such as topic, difficulty, style, or length of the text to be generated.

The term “predefined sentence template” refers to a pre-stored pattern of text that includes fixed phrases and variable placeholders, which is programmatically filled with evaluation results and request information to construct a prompt sentence.

The term “character string processing” refers to operations on character-based data, including concatenation, substitution, insertion, deletion, and formatting of text elements to generate or modify a prompt sentence or other textual data.

The term “explanation text” refers to natural language text generated by the generative AI model that provides descriptive or expository information about a learning field, topic, or concept for the benefit of the learning subject.

The term “learning content” refers to computer-deliverable educational material, including explanation text, examples, practice content, and similar textual information generated or selected for presentation to the learning subject.

The term “data structure transmittable to an output device” refers to a structured data representation, such as a formatted text object or message payload, which is suitable for transfer to and rendering by an output device or information processing terminal.

The term “information processing terminal for the learning subject” refers to a computing device operated by or accessible to the learning subject, such as a personal computer, tablet, smartphone, or similar terminal that presents learning content.

The term “response result information” refers to data indicating the content and outcome of a new response provided by the learning subject, including at least the textual answer and associated correctness or scoring information.

The term “operation history information” refers to data representing newly recorded operations or interactions performed by the learning subject, including, for example, selection events, navigation actions, and content viewing times.

The term “interactive problem information” refers to data representing problems or questions that require input or selection by the learning subject, including question texts, answer options, and structures enabling interactive responses.

The term “comprehension-check question” refers to a question designed to assess whether the learning subject has understood a previously presented explanation text or learning content.

The term “options” refers to a plurality of selectable answer candidates presented for a question, where the learning subject is expected to choose one or more of the options as a response.

The term “problem content” refers to a set of questions, options, and associated answer-related data generated for assessment purposes, including at least one question and a plurality of options.

The term “correct answer information” refers to data specifying which option or options among the presented options are deemed correct for each question included in the problem content.

The term “learning history information” refers to accumulated data relating to past learning sessions of the learning subject, including response history information, behavioral history information, and evaluation results stored over time.

The term “learning progress index” refers to a numerical indicator or derived metric representing progression of the learning subject's learning state over time, based on at least the learning history information.

The term “difficulty designation information” refers to data embedded in or associated with a prompt sentence that specifies a target difficulty or level of complexity for explanation text, learning content, or problem content to be generated.

The term “amount designation information” refers to data embedded in or associated with a prompt sentence that specifies a target volume, length, or quantity of explanation text, learning content, or problem content to be generated.

The term “continuously updating the learning content” refers to repeatedly generating and modifying learning content over multiple learning sessions, while adjusting prompt parameters such as difficulty designation information and amount designation information in accordance with new evaluations and the learning progress index.

In one embodiment, a server implements the claimed system by executing a computer program on a hardware platform comprising at least one central processing unit, a main memory, a nonvolatile storage device, a network interface, and an interface to an information storage device such as a relational database system. The server runs an operating system, for example a general-purpose server operating system, and application software implemented in a high-level programming language. The server additionally accesses software libraries for natural language processing, for example a tokenization and part-of-speech tagging library and a lemmatization and dependency analysis library, and statistical computing libraries for numerical analysis.

The server uses an information storage device that may be implemented by a database management system, such as a relational database or a document-oriented database. The server stores response history information, behavioral history information, learning history information, vocabulary difficulty tables, and configuration parameters in structured data formats. For example, the server stores learning history information in records including fields for a learner identifier, a timestamp, a text answer, a correctness flag, a question difficulty tag, and an elapsed time value. The server stores vocabulary difficulty information in records including fields for a word lemma, a difficulty score, and an associated difficulty band.

The server uses a generative AI model implemented as a neural network model deployed on a computation resource such as a graphics processing unit or a dedicated accelerator. In one embodiment, the generative AI model is a transformer-based language model comprising an input embedding layer, a plurality of self-attention layers, feed-forward sublayers, layer normalization units, and an output projection layer. The server accesses the generative AI model via an application programming interface exposed either by a local model-serving process or by a remote model-serving system connected over a network. The server provides prompt sentences to the generative AI model and receives natural language text as output tokens from the generative AI model.

The server defines internal data structures for representing a learning subject profile, including fields for a learner identifier, a current vocabulary ability level, a current comprehension ability level, and a learning progress index. The server maintains these profiles in the information storage device and updates them when new evaluations are performed. The server also defines data structures for prompt sentences, including fields for a learning field identifier, a topic description, a difficulty designation, an amount designation, and a formatted text string. By structuring these data objects explicitly, the server can perform efficient retrieval, update, and reuse of evaluation results and prompt sentences.

The server uses natural language processing technology to transform free-form learner answers into normalized feature representations. The server performs tokenization to split text into tokens, performs lemmatization to obtain canonical forms of words, filters out function words and symbols, and constructs frequency distributions over the remaining lemmas. The server calculates vocabulary diversity by computing, for example, a ratio of distinct lemmas to total tokens in the learner's history, as well as alternative measures such as moving averages of type-token ratios over time windows. The server calculates word occurrence frequency for each lemma and maps each lemma to a difficulty score by joining the lemmas with entries in the vocabulary difficulty table stored in the information storage device. The server then aggregates these difficulty scores into a vocabulary difficulty index, for example by computing a weighted average of difficulty scores weighted by occurrence frequency.

The server uses statistical processing technology to derive a vocabulary ability level and a comprehension ability level from these indices and from correctness information. For example, the server uses correctness information categorized by question difficulty tags to derive accuracy values for different bands, such as easy, medium, and hard. The server combines these statistics to determine numerical values representing vocabulary ability and comprehension ability. The server may then assign the learning subject to categorical levels such as beginner, intermediate, or advanced according to defined thresholds. Because the server uses precise numerical indices rather than simple counts of correct answers, the server is able to capture subtle changes in the learner's capabilities and to reduce noise in the evaluation, which improves the stability and accuracy of the adaptation process.

The server generates a prompt sentence for the generative AI model by combining evaluation results with request information regarding a learning field. The server stores predefined sentence templates containing both static phrases and variable placeholders. The server fills these placeholders with the vocabulary ability level, the comprehension ability level, the target difficulty designation, the learning field, the topic, the subtopic, and the desired amount designation. The server performs character string processing operations such as concatenation, insertion, and conditional inclusion of clauses. In one example, when a learning subject has an intermediate vocabulary ability level and a medium comprehension ability level and has requested content about a historical topic, the server generates a prompt sentence such as:

“The student has intermediate vocabulary skills and medium comprehension. The student is interested in history, specifically World War II. Generate an educational explanation about World War II using vocabulary appropriate for an intermediate learner. Write about 600 words. Explain important terms in simple language and avoid overly technical jargon.”

In this embodiment, the server constructs variations of the prompt sentence according to non-trivial rules that encode a mapping from numerical indices to textual constraints, such as specifying that a particular distribution of vocabulary difficulty indices requires explicit explanations of specialized terms. This rule set is different from a purely human strategy because the server uses continuous values and thresholds derived from large-scale logs, enabling fine-grained adjustments that a human teacher typically could not compute or apply at real-time scale.

The server transmits the prompt sentence to the generative AI model. Internally, the generative AI model encodes the prompt sentence into numerical vectors through an embedding layer and processes these vectors using a stack of self-attention layers. Each self-attention layer computes attention scores for each pair of token positions based on learned weight matrices and applies these scores to aggregate contextualized representations. The generative AI model then passes the aggregated representations through feed-forward sublayers and layer normalization. At the output, the generative AI model applies a linear projection and a softmax function to generate probability distributions over possible next tokens and iteratively samples or selects tokens according to those probabilities. The server receives the generated token sequence from the generative AI model and reconstructs the explanation text and learning content.

The server converts the generated explanation text and learning content into a data structure suitable for transmission, for example a structured message including fields for the text, the associated difficulty designation, the topic metadata, and timestamps. The server sends this structured message through the network interface to a terminal operated by the learning subject. The terminal may be a personal computer, a tablet device, or another information processing terminal running a web browser or a dedicated learning application. The terminal receives the message, parses the structure, and renders the explanation text in user interface components such as text display areas and scrolling regions. The user, who is the learning subject, reads the content and may perform further operations, such as selecting answers to questions or requesting additional explanations.

The server further uses the generative AI model to generate interactive problem content. After obtaining explanation text, the server produces another prompt sentence that instructs the generative AI model to create comprehension-check questions and options. For example, the server may generate a prompt sentence as follows:

“Based on the following explanation, create 5 multiple-choice questions to test the student's understanding. Each question must have 4 options (A, B, C, D) and only one correct answer. Use vocabulary suitable for an intermediate learner. At the end, provide the correct option for each question. Explanation: [here the explanation text is inserted].”

The server applies the same template-based and character string processing approach to ensure that the prompt sentence encodes not only the number of questions but also the difficulty band and style. The generative AI model then generates the problem content, including question texts, options, and correct answer indications. The server parses the generated text according to known structural markers, transforms the content into a structured representation of questions, options, and correct answer information, and transmits this representation to the terminal for interactive display.

The terminal presents the problem content through graphical user interface elements such as radio buttons or checkboxes. The user selects options as answers, and the terminal sends the selected options back to the server along with timing and interaction data. The server compares the selected options with the correct answer information and generates new correctness information and behavioral history information. The server appends these new records to the information storage device and updates the learning history information for the learning subject.

The server computes a learning progress index based on time-ordered learning history information. For example, the server applies an algorithm that aggregates recent correctness rates, recent vocabulary difficulty indices, and recency-weighted engagement times. By using time-decay functions or moving windows, the server produces a learning progress index that reflects both trend and stability of the learner's advancement. The server then uses this learning progress index to adjust difficulty designation information and amount designation information used in subsequent prompt sentences, for example by increasing targeted difficulty when the index exceeds a threshold or by decreasing it when the index falls below a different threshold. The server thereby implements a feedback control loop across multiple learning sessions.

By integrating evaluation, prompt construction, generative content production, distribution, and re-logging in a single computational pipeline, the server improves computer technology itself in several ways. The server reduces unnecessary network communication and computation at the generative AI model by specifying, through precisely tuned prompt sentences, only the difficulty bands and content lengths that are necessary for the current learning state. This focused prompting leads to shorter generated sequences when appropriate and minimizes revisions or repeated requests that would otherwise increase network traffic and GPU load. The server also reduces memory consumption and database I/O by representing learning history information in normalized and indexed tables and by aggregating historical features into compact indices, rather than repeatedly scanning raw text logs.

The server improves the accuracy and stability of adaptive content generation through its specific combination of natural language processing and statistical processing. Instead of relying solely on coarse user-level tags or simple counts, the server uses derived indices such as vocabulary difficulty indices and learning progress indices that are computed from detailed token-level analyses and performance histories. This algorithmic approach produces more consistent difficulty control across different topics and learning fields, thereby improving the predictability and reliability of system behavior from a computational standpoint.

The server further improves computation efficiency by decoupling evaluation logic from generation logic. The server computes the vocabulary ability level and comprehension ability level periodically or upon significant new data, stores these values, and reuses them across multiple prompt generations until a new evaluation is necessary. This design avoids redundant recalculations for every content request and allows the server to schedule heavy evaluation tasks at suitable times, such as low-traffic periods, thereby balancing computing load and improving throughput.

The server's internal processing is distinct from mere human manual adaptation, because the server applies algorithmic rules that combine numerical thresholds, time-series statistics, and structured mappings from continuous indices into textual constraints. For example, the server may adjust amount designation information according to non-linear functions of the learning progress index so that content length grows rapidly in intermediate stages and then saturates at advanced stages. These non-intuitive mappings are specifically designed to improve the trade-off between learner engagement and computational resource usage, and they are applied consistently by the server at large scale, which could not be feasibly achieved by human operators.

In one variation, the server uses different types of generative AI models. For example, the server may use a larger transformer model hosted in a remote data center for generating long explanations and a smaller transformer model hosted locally for generating short questions or hints, with the same prompt sentence structure but different decoding parameters. The server may also adapt decoding parameters such as temperature and top-k thresholds based on the vocabulary ability level and comprehension ability level; for example, the server may use lower entropy (lower temperature) for beginner levels to produce more predictable wording and higher entropy for advanced levels to increase lexical variety. These model parameter adjustments are encoded by the server in a structured configuration that is derived from the computed indices, further demonstrating a close coupling between evaluation and generative processing.

In another embodiment, the server employs alternative algorithms for calculating the learning progress index, such as Bayesian updating, reinforcement learning value estimates, or clustering-based segmentation of learner trajectories. The server can then select different prompt templates or difficulty mappings for different clusters of learners that exhibit similar patterns. Even in these variations, the core technical effect remains: the server transforms rich, time-varying learner logs into compact, machine-interpretable indices and uses these indices to programmatically configure generative AI model requests and to thereby optimize computational pathways within the learning support system.

The terminal in these embodiments serves not only as a display device but also as an instrumented interaction device that captures fine-grained behavioral history information. For example, the terminal may measure time taken to scroll through the explanation text, positions where the user pauses or re-reads content, and frequencies of switching between explanation content and questions. The terminal transmits these metrics to the server in structured messages. The server incorporates these additional features into the behavioral history information and into the learning history information, further enriching the input space for evaluation and enabling more accurate and responsive difficulty control. This tight integration between terminal instrumentation and server-side evaluation contributes to a reduction in misalignment between learner state and generated content, which in turn reduces redundant requests and re-generation, improving overall system efficiency.

Overall, the described embodiments provide a concrete implementation of a server that uses specific data structures, numerical indices, and neural network model interactions to accomplish adaptive generation of educational text and problem content in a manner that improves processing efficiency, accuracy, and resource utilization of the underlying computing system, rather than merely automating a human teaching workflow.

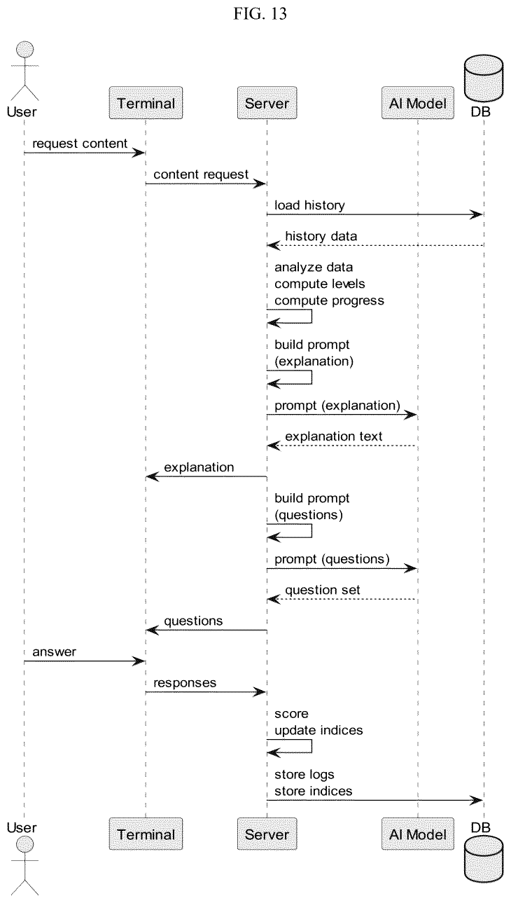

The following describes the processing flow using FIG. 13.

### Step 1

The terminal transmits a content request to the server.

The terminal sets, as input, a learner identifier, a requested learning field, an optional topic or subtopic, and optional constraints such as desired length or target level. The terminal packages these items into a structured request and sends the request over a network connection to the server. The server receives this request as raw request data and parses it into internal variables representing the learner identifier, the requested field, and the constraint parameters. The server thereby obtains, as output of this step, a normalized request object ready for further processing.

### Step 2

The server acquires learning history information from an information storage device.

The server uses, as input, the learner identifier extracted in Step 1. The server constructs a database query that selects records containing response history information and behavioral history information for that learner. The server executes the query against the information storage device and retrieves records including text answers, correctness flags, timestamps, difficulty tags, and interaction metrics such as viewing times. The server aggregates the retrieved records into an in-memory data structure, for example a list of answer objects and a list of behavior events, and outputs this structured learning history information for further analysis.

### Step 3

The server preprocesses text information and correctness information.

The server uses, as input, the text answers and correctness flags contained in the learning history information from Step 2. The server performs data cleaning operations such as trimming whitespace, converting text to a canonical character encoding, and discarding empty or extremely short answers. The server then applies natural language processing to each remaining answer, including tokenization, lemmatization, and removal of stop words and non-alphabetic tokens. The server aligns each processed answer with its corresponding correctness flag. As output, the server produces a normalized text corpus of learner answers and an aligned set of correctness labels suitable for statistical analysis.

### Step 4

The server computes vocabulary statistics and difficulty indices.

The server uses, as input, the normalized text corpus from Step 3 and a vocabulary difficulty table stored in the information storage device. The server counts occurrences of each lemma and calculates word occurrence frequency distributions. The server computes vocabulary diversity metrics, such as the ratio of distinct lemmas to total tokens and moving averages over time segments. The server then joins the lemma list with the vocabulary difficulty table to obtain difficulty scores for each lemma and calculates aggregated vocabulary difficulty indices by computing weighted averages and other summary statistics. As output, the server generates numerical features representing word occurrence frequency, vocabulary diversity, and vocabulary difficulty indices for the learner.

### Step 5

The server evaluates a vocabulary ability level and a comprehension ability level.

The server uses, as input, the numerical features produced in Step 4 and the correctness labels and difficulty tags from the learning history information. The server calculates correctness rates for different difficulty bands and overall accuracy. The server combines these statistics with the vocabulary difficulty indices using predetermined evaluation rules, such as thresholding and weighted averaging, to derive continuous scores for vocabulary ability and comprehension ability. The server then maps these scores to categorical levels, for example beginner, intermediate, or advanced. As output, the server obtains a vocabulary ability level and a comprehension ability level associated with the learner.

### Step 6

The server calculates a learning progress index.

The server uses, as input, time-ordered learning history information, including timestamps, evaluation results from past sessions, and recent correctness rates. The server applies a time-series algorithm, such as exponential decay weighting or sliding window averaging, to emphasize recent performance while retaining information about long-term trends. The server calculates a single numerical learning progress index that reflects the direction and magnitude of the learner's progress. As output, the server produces an updated learning progress index that will influence subsequent content generation parameters.

### Step 7

The server determines target difficulty and amount designations.

The server uses, as input, the vocabulary ability level, the comprehension ability level, the learning progress index from Step 6, and any explicit difficulty or length constraints from the initial request. The server applies a decision rule set that maps these inputs to a target difficulty designation, such as lower-intermediate or upper-intermediate, and an amount designation, such as an approximate word count or number of questions. The server may adjust the designations non-linearly based on the learning progress index to promote growth while avoiding excessive jumps in difficulty. As output, the server selects and stores target difficulty and amount parameters that will be embedded in a prompt sentence.

### Step 8

The server generates a prompt sentence for a generative AI model.

The server uses, as input, the target difficulty designation and amount designation from Step 7, the vocabulary and comprehension levels from Step 5, and the learning field, topic, and subtopic from Step 1. The server selects a predefined sentence template suitable for explanation content and fills placeholders with these values using string concatenation and substitution operations. The server optionally inserts conditional clauses based on thresholds, for example requesting explicit definition of technical terms when the vocabulary ability level is below a certain value. As output, the server generates a prompt sentence, such as:

“The student has intermediate vocabulary skills and medium comprehension. The student is interested in history, specifically World War II. Generate an educational explanation about World War II using vocabulary appropriate for an intermediate learner. Write about 600 words. Explain important terms in simple language and avoid overly technical jargon.”

### Step 9

The server requests explanation text from the generative AI model.

The server uses, as input, the prompt sentence created in Step 8. The server packages the prompt sentence and associated parameters, such as a maximum token limit and decoding settings, into a request message to the generative AI model. The server sends this message through an application programming interface to the model-serving component. The generative AI model processes the prompt sentence using its internal neural network structure and generates a sequence of output tokens representing explanation text. The server receives this sequence and reconstructs it into a coherent text string. As output, the server obtains explanation text and learning content aligned with the evaluation results.

### Step 10

The server prepares and transmits explanation content to the terminal.

The server uses, as input, the explanation text from Step 9, the target difficulty designation, and the topic metadata. The server embeds these items into a structured response message, possibly including identifiers and timestamps. The server performs any required formatting, such as segmenting the text into paragraphs or marking headings. The server then transmits the structured message to the terminal over the network. The terminal receives the message, parses its fields, and renders the explanation text in user interface components. As output of this step, the user can view the generated explanation content on the terminal.

### Step 11

The server generates a prompt sentence for interactive problem content.

The server uses, as input, the explanation text obtained in Step 9 and the same or updated difficulty designation and amount designation from Step 7. The server selects a second template designed for problem generation, and it inserts the explanation text and parameters such as the number of desired questions and the vocabulary band into the template. The server performs character string processing to generate a complete prompt sentence, for example:

“Based on the following explanation, create 5 multiple-choice questions to test the student's understanding. Each question must have 4 options (A, B, C, D) and only one correct answer. Use vocabulary suitable for an intermediate learner. At the end, provide the correct option for each question. Explanation: [explanation text].”

As output, the server obtains a problem-generation prompt sentence ready for submission to the generative AI model.

### Step 12

The server requests problem content from the generative AI model.

The server uses, as input, the problem-generation prompt sentence from Step 11. The server constructs a model request analogous to that in Step 9 but configured for shorter outputs suitable for questions and options. The server sends the request to the generative AI model and receives generated text containing multiple questions, associated answer options, and indicated correct answers. The server parses the generated text, detects structural delimiters, and transforms the generated text into a structured representation that includes individual question texts, option lists, and correct answer information. As output, the server obtains structured problem content.

### Step 13

The server delivers interactive problem content to the terminal and records user responses.

The server uses, as input, the structured problem content from Step 12. The server packages the questions, options, and correct answer identifiers into a message addressed to the terminal. The terminal receives the message, generates interactive user interface elements such as buttons or selection fields, and displays the questions to the user. The user reads the questions and operates the terminal to select options or input answers. The terminal records the selected options together with timestamps and interaction data and transmits this response data back to the server. The server receives the response data and compares the selected options to the stored correct answers, thereby generating new correctness information and updated behavioral history information. As output, the server produces new evaluation records for the current session.

### Step 14

The server updates learning history information and evaluation indices.

The server uses, as input, the new correctness information and behavioral history information from Step 13, together with the previously stored learning history information and evaluation indices. The server appends new response records to the information storage device and recalculates or incrementally updates vocabulary statistics, comprehension statistics, and the learning progress index. The server modifies the vocabulary ability level and comprehension ability level if thresholds are crossed or if trends indicate significant change. As output, the server maintains an up-to-date learning history and set of evaluation indices, which will be used as inputs to prompt generation and content generation in subsequent iterations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning systems generally select and deliver learning content based on coarse-grained parameters such as a static difficulty level or a simple history of correct and incorrect answers. In such systems, a processing device typically retrieves test scores from a storage device and applies fixed rules to select next content. This approach suffers from several technical limitations.

First, the processing device does not maintain a fine-grained, machine-usable representation of a learner's state that simultaneously reflects vocabulary capability, comprehension capability, learning progress over time, and emotional state. As a result, the internal data structures used by the processor for content selection are shallow and static, which limits the ability of the computer system to adapt its behavior in real time and leads to suboptimal utilization of computational resources.

Second, even where a generative artificial intelligence model is used, conventional systems often treat the model as a black-box text generator and provide only simplistic prompt sentences, such as a generic request for “intermediate-level content.” Such prompt sentences fail to encode structured learner indexes and do not close the feedback loop between model outputs and subsequent learner performance. Therefore, the processor cannot systematically optimize its use of the generative artificial intelligence model, and the model cannot be effectively steered to generate machine-tailored content.

Third, existing systems rarely integrate multimodal emotional state analysis into the same computational loop that governs content generation and difficulty control. Emotional information, when handled at all, is often processed in isolation and is not fused into a unified learner profile alongside vocabulary, comprehension, and progress indexes. Consequently, the processor cannot perform algorithmic decisions that jointly consider cognitive and emotional metrics, and the system cannot dynamically adjust content generation parameters or prompt sentences based on emotion-related signals.

Fourth, conventional architectures typically lack a mechanism for persistently logging, at scale, the mapping between (i) prompt sentences supplied to the generative artificial intelligence model, (ii) generated learning content, and (iii) subsequent learner performance and emotional indexes. Without this structured logging and subsequent analysis, the processor cannot improve its internal rules or models for prompt generation or content generation conditions. This results in a computer system whose behavior remains largely static and hand-tuned, rather than being data-driven and self-optimizing.

Accordingly, there is a need for a computer-implemented system that improves the way a processor (i) acquires and analyzes response information, behavior information, and multimodal emotion information, (ii) constructs and updates structured indexes representing learner state, (iii) generates and refines prompt sentences for a generative artificial intelligence model based on these indexes, and (iv) records and exploits the relationship between prompt sentences, generated outputs, and resulting learner performance and emotional responses. By redesigning the internal information processing pipeline in this manner, the underlying computer technology for adaptive content generation and delivery can be improved in terms of accuracy, responsiveness, and efficiency of the processor's decision-making and model control.

The specific processing by the specific processing unit 290 of the data processing device 12 in Application Example 2 is realized by the following means.

The present invention provides a server comprising a processor and a storage device, the processor being configured to acquire, from the storage device, response information and behavior information of a learner and to process the response information by a natural language processing function in order to calculate a vocabulary index and a comprehension index, to process the behavior information in order to calculate a learning progress index, to further acquire image information and audio information transmitted from a terminal device and to process the image information and the audio information by an image processing function and an audio processing function in order to calculate an emotion index, to generate a prompt sentence to be input to a generative artificial intelligence model based on the vocabulary index, the comprehension index, the learning progress index, and the emotion index, to input the prompt sentence to the generative artificial intelligence model in order to cause the generative artificial intelligence model to generate learning content information, to provide the learning content information to the terminal device, to acquire response information of the learner to interactive questions or quizzes presented by the terminal device and to update at least one of the comprehension index and the learning progress index based on the acquired response information, to automatically change at least one of a subsequent prompt sentence and subsequent learning content information based on an update result of the indexes, and to record, in the storage device, the prompt sentence, the learning content information generated from the prompt sentence, and performance information and the emotion index of the learner associated with the learning content information, and to update at least one of a generation rule of the prompt sentence and a generation condition of the learning content information based on the record. This enables the server to maintain and refine a unified, machine-usable learner state representation that combines vocabulary, comprehension, progress, and emotional metrics, to dynamically control the generative artificial intelligence model through structured and adaptively updated prompt sentences, and to improve the internal content selection and generation logic of the computer system over time based on logged relationships between prompts, generated outputs, and learner outcomes, thereby enhancing the technical performance and adaptability of the learning system.

The term “processor” refers to a hardware information processing element, such as a central processing unit or another computing circuitry, that executes instructions to perform data acquisition, analysis, generation, and control operations described in the present specification.

The term “storage device” refers to a hardware data retention element, such as a memory or a non-volatile storage unit, that stores programs, learner data, indexes, prompt sentences, generated content, and logs used and produced by the processor.

The term “terminal device” refers to an end-user computing apparatus, such as a mobile communication device, a tablet device, a wearable device, or a general-purpose computer, that presents learning content to a learner, acquires input from the learner, and transmits information such as responses, behavior data, and sensor data to the server.

The term “learner” refers to a human user who receives learning content from the system, provides responses to questions or quizzes, and whose cognitive and emotional state is analyzed by the processor.

The term “response information” refers to data representing content of answers or inputs provided by the learner to questions, quizzes, or other interactive elements, including, for example, selected options, typed text, spoken answers, and associated metadata such as timestamps.

The term “behavior information” refers to data representing interaction patterns of the learner with the terminal device and the presented content, including, for example, time spent on items, scrolling patterns, number of hint requests, input speed, and other observable usage metrics.

The term “vocabulary capability” refers to a quantitative or qualitative property indicating a range, richness, and sophistication of lexical items that the learner can understand or use, as inferred from response information and related textual data.

The term “comprehension capability” refers to a quantitative or qualitative property indicating an ability of the learner to correctly understand, interpret, or apply presented information, as inferred from correctness, relevance, or depth of responses to content.

The term “learning progress index” refers to a structured and machine-readable indicator calculated by the processor that represents a temporal evolution of the learner's mastery over one or more topics, including information such as completion status, performance trends, and stability of knowledge.

The term “vocabulary index” refers to a structured and machine-readable indicator calculated by the processor that numerically or categorically represents the vocabulary capability of the learner based on analysis of textual response information.

The term “comprehension index” refers to a structured and machine-readable indicator calculated by the processor that numerically or categorically represents the comprehension capability of the learner based on correctness, semantic relevance, and complexity of responses.

The term “image information” refers to visual data, such as still images or image frames extracted from video, captured by an image sensor of the terminal device and transmitted to the server for analysis of facial expressions and related visual features.

The term “audio information” refers to acoustic data, such as audio signals or segments, captured by an audio sensor of the terminal device and transmitted to the server for analysis of vocal characteristics and related features.

The term “image processing function” refers to a programmatic capability executed by the processor to analyze image information, including operations such as face detection, feature extraction, and pattern recognition applied to visual data.

The term “audio processing function” refers to a programmatic capability executed by the processor to analyze audio information, including operations such as feature extraction, speech processing, or prosody analysis applied to acoustic data.

The term “facial expression features” refers to numerical or symbolic descriptors extracted from image information that characterize a configuration or movement of facial components, such as eyes, eyebrows, and mouth, and that are used to infer an emotional state.

The term “audio features” refers to numerical or symbolic descriptors extracted from audio information that characterize attributes of sound, such as pitch, intensity, timbre, tempo, or spectral properties, and that are used to infer an emotional state or affective content.

The term “emotion index” refers to a structured and machine-readable indicator calculated by the processor that numerically or categorically represents an estimated emotional state of the learner over time, such as frustration, neutrality, or engagement.

The term “natural language processing function” refers to a programmatic capability executed by the processor to analyze and manipulate textual data, including operations such as tokenization, part-of-speech tagging, parsing, semantic similarity analysis, and other language-related processing.

The term “generative artificial intelligence model” refers to a machine learning model, such as a neural network model, configured to generate information including natural language text or structured content in response to input data such as a prompt sentence.

The term “prompt sentence” refers to a textual or structured instruction string generated by the processor and supplied as input to the generative artificial intelligence model to control or condition an output of the generative artificial intelligence model.

The term “learning content information” refers to data representing one or more learning units to be presented to the learner, including, for example, explanatory text, examples, practice problems, quizzes, feedback messages, and associated metadata such as topic and difficulty.

The term “interactive questions or quizzes” refers to question items that the learner can actively respond to via the terminal device, including multiple-choice questions, short-answer questions, open-ended questions, or other problem formats that support input and evaluation.

The term “performance information” refers to data representing an outcome of the learner's interaction with learning content, including metrics such as correctness of answers, scores, response times, and other measures of task success or failure.

The term “generation rule of the prompt sentence” refers to a set of parameters, algorithms, or decision logic used by the processor to construct a prompt sentence from underlying indexes, historical data, or context information.

The term “generation condition of the learning content information” refers to a set of parameters, constraints, or control values provided to the generative artificial intelligence model, including desired topic, difficulty, style, or structure, that influence generation of learning content information.

The term “planning information” refers to structured data that specifies a future learning path for the learner, including determination of a next learning unit, a type and difficulty of a next task, and sequencing information used by the processor to orchestrate content delivery.

The term “lesson configuration information” refers to structured data representing an internal design of a lesson, including elements such as objectives, topics, explanation sections, and practice sections, which is used as or within a prompt sentence to cause the generative artificial intelligence model to generate concrete learning content information.

The term “feedback information” refers to data representing messages or guidance provided to the learner in response to performance information and emotion indexes, including, for example, encouraging expressions, suggestions for improvement, and indications of next steps.

The term “review learning content information” refers to learning content information that is specifically configured to revisit or reinforce previously presented topics, typically with adjusted difficulty or additional explanation, in order to remedy deficiencies indicated by the indexes.

In one embodiment, a server, a terminal, and a user cooperate to implement the claimed system. The server includes a processor, a storage device, and a network interface. The terminal includes a display, one or more input devices, an image sensor, an audio sensor, and a communication interface. The user operates the terminal to receive learning content and to provide responses. The server executes computer programs that implement the processing of learner information, generation of prompt sentences, control of a generative AI model, and adaptation of learning content.

The server uses general-purpose computing hardware, such as a central processing unit, a graphics processing unit, and semiconductor memory, together with a non-volatile storage device such as a solid-state drive. The server executes software components implemented, for example, in a programming language and using libraries for natural language processing, numerical computation, and machine learning. The server maintains one or more relational or non-relational databases to store learner profiles, content metadata, prompt sentences, generative AI outputs, performance logs, and emotion logs.

The terminal uses a processing unit, a memory, an integrated camera as the image sensor, and an integrated microphone as the audio sensor. The terminal executes a client program such as a mobile application or a web application. The terminal presents learning content received from the server on the display, captures user input through a touch panel or pointing device, and transmits captured responses, behavior information, and sensor data to the server. The user interacts with the terminal by reading text, listening to audio, watching video, answering questions, and speaking or displaying facial expressions during learning.

The server maintains, in the storage device, structured data records representing a learner state. In one configuration, the server represents the learner state as a composite data structure including fields for a vocabulary index, a comprehension index, a learning progress index, and an emotion index. The vocabulary index can be a vector of numerical values per vocabulary band, the comprehension index can include per-topic performance metrics, the learning progress index can store mastery probabilities per topic and timestamps, and the emotion index can store class probabilities for emotional categories and a time-series of these probabilities. The server updates each of these indexes in response to incoming data from the terminal.

The server processes response information of the user using a natural language processing pipeline. The server uses a tokenization module to segment answer text into tokens, a tagging module to assign part-of-speech labels, and a parsing or embedding module to compute syntactic or semantic representations. The server counts token frequencies and computes statistics such as type-token ratio, average sentence length, and distribution over lexical difficulty bands. The server uses these statistics to calculate the vocabulary index. The server compares the semantic representation of an answer to a reference answer representation to compute a similarity score and uses this score, together with correctness flags and response times, to calculate the comprehension index.

The server processes behavior information to derive the learning progress index. The server aggregates data such as time spent on content, number of attempts per item, and sequence of modules visited. The server encodes this information in a data structure such as a feature vector per topic and uses, for example, a logistic or probabilistic model to estimate mastery probabilities. The server stores these estimates in the learning progress index, which is represented as a lookup table keyed by topic identifiers and containing current mastery values, last update times, and trend indicators.

The server processes image information and audio information received from the terminal in order to estimate the emotion index. The server uses an image processing function that includes detecting a face region, locating facial landmarks, normalizing the face images, and feeding them into a neural network for emotion classification. In one embodiment, the server uses a convolutional neural network having multiple convolutional layers, pooling layers, and fully connected layers with an output layer providing probabilities for emotion classes such as happiness, neutrality, confusion, and frustration. The server uses a softmax function at the output layer and trains the network beforehand using labeled facial expression datasets with a cross-entropy loss function and stochastic gradient descent or another optimization technique.

The server uses an audio processing function to extract acoustic features such as pitch, energy, and spectral coefficients from the audio information. The server may use a neural network, such as a recurrent neural network or a transformer-based architecture, to classify the emotional tone of the speech. The server optionally uses a speech-to-text function to transcribe audio to text and then applies natural language processing to the transcribed text to infer sentiment. The server fuses the visual and auditory emotion classification results, for example by computing a weighted average of class probabilities or by using a small fusion network, and stores the resulting distribution as the emotion index in the learner state data structure.

The server generates a prompt sentence as an explicit and structured control signal to the generative AI model. The server builds the prompt sentence using the vocabulary index, the comprehension index, the learning progress index, and the emotion index. In one example, the server constructs natural language instructions that embed the learner's level, weaknesses, and emotional state:

“The user's vocabulary level is intermediate and the user has difficulty with English relative clauses. Please generate an English reading passage of about 500 words suitable for an intermediate learner, containing multiple examples of relative clauses (‘who’, ‘which’, ‘that’), followed by 5 comprehension questions and brief explanations of the relative clauses used.”

In another example, the server constructs a prompt sentence for emotion-aware remedial content:

“The user is an intermediate English learner who has difficulty with relative clauses and is currently showing signs of frustration (frequent frowning, low quiz accuracy). Please generate a short, very simple explanation of relative clauses with clear step-by-step examples, followed by 3 easy practice questions. Use supportive and encouraging language.”

In a further example related to planning, the server constructs a prompt sentence for the design of a next lesson:

“Given this learner profile (math: good at limits, weak at integration, often frustrated by long proofs), propose the next lesson outline with short intuitive explanations and 5 scaffolded practice problems.”

The server supplies the prompt sentence to the generative AI model. The generative AI model is implemented, in one embodiment, as a neural network configured for sequence generation. The generative AI model can have a transformer architecture with multiple attention layers, feedforward layers, and positional encoding, trained on large-scale text corpora and optionally fine-tuned on educational content. The server stores, in the storage device, model parameters such as weight matrices, bias vectors, and layer normalization parameters. During training, the server minimizes a loss function such as cross-entropy between the generated sequence and a target sequence and updates the parameters using gradient-based methods such as Adam optimization. During inference, the server uses decoding strategies such as beam search or top-k sampling with a temperature parameter to generate diverse but controlled outputs.

The server configures the generative AI model with generation conditions, including maximum sequence length, allowed languages, and structural constraints such as “include exactly 5 questions” or “produce JSON-like markers around answer keys.” The generative AI model receives the prompt sentence as input and performs attention-based computation over the prompt tokens to generate continuation tokens that represent the learning content information. The server collects the generated tokens, converts them into text or structured content, and validates them against basic constraints such as length and topic filters.

The server stores the generated learning content information, including explanatory text, examples, practice questions, and answer keys, in the storage device. The server associates each generated content item with the originating prompt sentence and with metadata such as topic identifiers, estimated difficulty, and timestamps. The server transmits the learning content information to the terminal via the network interface.

The terminal receives the learning content information and renders it on the display. The terminal generates user interface elements such as text sections, answer fields, and buttons. The user reads the content and interacts with the questions. The terminal records response information, such as selected answer options, typed text, and response times per item. The terminal also continues to capture image information and audio information, for example at predefined intervals or when the user is answering a question. The terminal sends these data back to the server.

The server analyzes the new response information and behavior information in the same manner as described above to update the comprehension index and the learning progress index. The server incorporates the new emotion index values computed from the latest sensor data. The server then modifies its prompt sentence generation logic by using the updated indexes. Because the server stores the learner state in structured indexes and uses those indexes as features in prompt generation, the system provides a fine-grained and machine-usable representation of learner state that improves the control of the generative AI model.

The server records, in the storage device, the prompt sentence, the generated learning content information, performance information (such as scores and response times), and the emotion index values associated with the use of the generated content. The server maintains this data as a log table or set of linked tables. The server later analyzes these records offline or in the background using numerical computation libraries and machine learning algorithms. For example, the server can train a secondary model that predicts learning gain or emotion change from features describing the prompt sentence and the generated content. The server then uses this secondary model to adjust generation rules for prompt sentences, such as weighting certain index features more heavily or adding explicit instructions for question types that historically correlate with better performance.

The server thus does not merely automate human selection of content but modifies internal data structures, prompt generation algorithms, and generative AI configurations over time based on systematic analysis of prompt-output-outcome relationships. This causes a change in the operation of the computer system itself, in that the processor refines its control parameters and generation rules to reduce computation on ineffective content and to prioritize generation paths that yield higher learning gains and lower frustration, thereby improving the efficiency and accuracy of subsequent content generation runs.

The server improves computational efficiency by combining multiple learner signals into compact indexes. By computing the vocabulary index, comprehension index, learning progress index, and emotion index as fixed-size vectors or structured objects, the server can use vectorized operations and matrix multiplications for decision-making and prompt generation, rather than repeatedly traversing raw log data. This reduces processing time for determining the next content and decreases memory accesses. The server can also use caching of precomputed index-to-prompt mappings or templates to further speed up processing.

The server improves the accuracy of content selection and emotion-aware adaptation by soft-fusing multimodal emotion signals and by using them directly in control of the generative AI model. Because the emotion index is computed as a probability distribution over emotion classes and is tightly coupled with the generative AI control signals, the server can systematically adjust difficulty, tone, and structure of content in response to emotional fluctuations. This differs from simple rule-based thresholds and leads to more stable behavior of the system, reducing oscillations where a learner is repeatedly presented with content of inappropriate difficulty.

The server also improves data management by maintaining explicit relational links between indexes, prompt sentences, generated content, and performance logs. This structure allows the server to execute efficient queries for, for example, all content generated under a given index pattern or all prompts that resulted in reduced frustration. The server can then perform batch updates to generation rules or model hyperparameters. As a result, the server can decrease the number of ineffective model calls and reduce overall network and computation load.

In one variant, the server uses a first generative AI model to generate high-level lesson configuration information from the learner indexes and uses a second generative AI model to transform the lesson configuration information into detailed learning content. The server thus separates planning and realization. The first model can be a smaller, specialized network trained to output structured lesson outlines, while the second model can be a larger language model for text generation. This separation allows the server to reduce overall computation by limiting calls to the larger model when content structure has not significantly changed.

In another variant, the server executes part of the emotion processing at the terminal. The terminal runs a lightweight face detection and feature extraction algorithm and sends only feature vectors rather than full images. This reduces network bandwidth and protects privacy. The server then runs only the classification part of the emotion model. This distribution of processing load results in reduced network traffic and improved latency for emotion-aware adaptations.

In still another variant, the server uses dimension reduction techniques such as principal component analysis to compress the learner state indexes into lower-dimensional feature vectors before storing them. This reduces storage requirements and accelerates subsequent retrieval and modeling. The server can then reconstruct important aspects of learner state from the compressed representation for prompt generation.

The system thus implements, in hardware and software, a specific and non-conventional pipeline in which the server maintains a unified index-based learner profile, uses that profile to generate structured prompt sentences, controls a generative AI model via these prompt sentences, and logs and exploits the relationship between prompts, content, and outcomes to iteratively improve its internal algorithms. The server cooperates with the terminal and with the user's interactions and sensor data to realize a technical effect of improved computational decision-making, reduced processing time, and increased accuracy and stability in adaptive content generation.

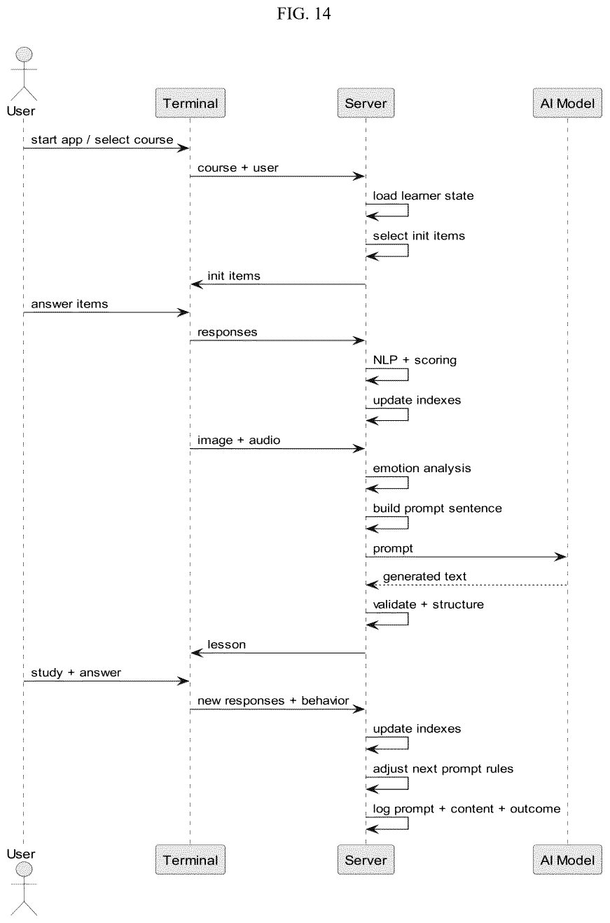

The following describes the processing flow using FIG. 14.

### Step 1

User starts a learning session and selects a course.

User operates the terminal to launch a learning application and to select a target course (for example, language, history, or mathematics).

Input: User's selection operations (course ID, user ID).

Output: Selection data transmitted from the terminal to the server.

Terminal acquires the user ID from local storage, detects the selected course from UI events, and sends a structured message including the user ID and course ID to the server via a communication interface.

### Step 2

Server initializes a learner state.

Server receives the selection data and accesses a storage device to retrieve an existing learner state record associated with the user ID and course ID, or creates a new record if none exists.

Input: User ID, course ID.

Output: Initial learner state including a vocabulary index, a comprehension index, a learning progress index, and an emotion index.

Server loads prior scores, completion history, and previous emotion logs from a database and computes or initializes each index as numerical vectors or tables; for example, server sets default mastery probabilities and sets the emotion index to a neutral distribution.

### Step 3

Server prepares initial assessment content.

Server determines whether an initial or diagnostic assessment is needed based on the learner state, such as absence of prior data or low confidence in existing indexes.

Input: Learner state (indexes, history flags).

Output: Assessment item set and associated metadata.

Server queries a content repository, filters items by topic and difficulty, and selects a subset of questions (e.g., multiple-choice and short-answer) tagged with relevant skills, then sends this item set as structured content to the terminal.

### Step 4

Terminal presents assessment items and records responses.

Terminal receives the assessment item set and renders questions and input controls on the display, and starts per-item timers.

Input: Assessment item set from the server.

Output: Response information (answers, timestamps) sent to the server.

User reads each item and provides answers; terminal captures selected options or text, records start and end times for each item, and formats these data into a structured response payload for transmission to the server.

### Step 5

Server performs natural language processing on responses.

Server receives the response information and separates objective answers from free-text answers.

Input: Response information from the terminal.

Output: Processed text features and correctness flags.

Server compares objective answers to stored correct answers to produce correctness flags; server applies a tokenization function to free-text answers, counts token frequencies, computes lexical diversity metrics, and, optionally, generates vector embeddings using a language model; server stores these intermediate features for later index computation.

### Step 6

Server calculates vocabulary and comprehension indexes.

Server uses the processed text features and correctness flags to update vocabulary and comprehension indexes.

Input: Text features, correctness flags, prior vocabulary index, prior comprehension index.

Output: Updated vocabulary index and comprehension index.

Server maps tokens to difficulty bands using a wordlist, aggregates counts per band, and updates vocabulary level vectors; server evaluates semantic similarity between free-text answers and reference answers, combines similarity scores with correctness and response time, and writes the derived scores into the comprehension index for each topic.

### Step 7

Server processes behavior information to update the learning progress index.

Server extracts behavior information such as time-on-item and number of attempts from the response payload and usage logs.

Input: Behavior information and prior learning progress index.

Output: Updated learning progress index.

Server constructs feature vectors per topic based on behavior metrics, applies a probabilistic or logistic model to estimate mastery probabilities, and updates the learning progress index table with new mastery values and timestamps.

### Step 8

Terminal captures image and audio information for emotion analysis.

Terminal operates an image sensor and an audio sensor while the user is engaged with assessment or learning content.

Input: User's physical interaction (facial expressions, voice).

Output: Image information and audio information sent to the server.

Terminal captures frames from the camera at fixed intervals, captures audio segments from the microphone, optionally compresses or pre-processes the data, and transmits these sensor data to the server with timestamps and context identifiers.

### Step 9

Server computes the emotion index from multimodal data.

Server receives the image information and audio information and runs image and audio processing functions.

Input: Image information, audio information, prior emotion index.

Output: Updated emotion index.

Server detects faces, extracts facial landmarks, normalizes face crops, and feeds them into a trained neural network classifier; server extracts acoustic features from the audio, runs an emotion classification model, and optionally runs speech-to-text and text sentiment analysis; server fuses probabilities from each modality to produce a combined emotion distribution, which it stores as the latest emotion index for each time segment.

### Step 10

Server generates a prompt sentence for the generative AI model.

Server reads the updated vocabulary index, comprehension index, learning progress index, and emotion index from the learner state.

Input: Updated indexes (vocabulary, comprehension, progress, emotion).

Output: Prompt sentence text.

Server constructs a natural language instruction that encodes these indexes, such as: “The user's vocabulary level is intermediate and the user has difficulty with English relative clauses. Please generate an English reading passage of about 500 words suitable for an intermediate learner, containing multiple examples of relative clauses (‘who’, ‘which’, ‘that’), followed by 5 comprehension questions and brief explanations of the relative clauses used.”

Server concatenates fixed template segments with dynamically generated phrases derived from the indexes and stores the resulting prompt sentence in the storage device.

### Step 11

Server invokes the generative AI model with the prompt sentence.

Server passes the prompt sentence as input to a generative AI model implemented as a neural network configured for text generation.

Input: Prompt sentence.

Output: Generated learning content information.

Server encodes the prompt sentence into tokens, feeds the tokens into the generative AI model, and configures generation parameters (maximum length, sampling strategy); the generative AI model computes output token sequences based on attention and learned weights, and the server decodes these tokens into text representing explanations, examples, questions, and answers.

### Step 12

Server validates and structures the generated learning content.

Server checks the generated text against specified constraints and structures it into discrete content elements.

Input: Raw generated text from the generative AI model.

Output: Structured learning content information.

Server parses the text into sections (title, body paragraphs, question list, answer list), checks for minimal length and topic consistency, and assigns metadata such as topic ID and estimated difficulty; server stores the structured content along with the originating prompt sentence and sends the content to the terminal.

### Step 13

Terminal presents personalized learning content.

Terminal receives the structured learning content information from the server and renders it as an interactive lesson.

Input: Structured learning content information.

Output: User-visible content and interaction controls.

Terminal displays text and questions, creates controls for answer input, and, if included, displays feedback hints or explanations; user studies the content and interacts with the questions; terminal prepares to record new response and behavior data in the next cycle.

### Step 14

User interacts with the personalized content and provides new responses.

User reads explanations, attempts questions, and optionally requests hints through the terminal interface.

Input: Displayed learning content and controls.

Output: New response information and additional behavior information.

Terminal captures the user's selected choices, typed answers, hint requests, scrolling behavior, and time stamps, and sends these new data to the server for further analysis.

### Step 15

Server updates indexes based on new performance.

Server processes the new response and behavior information to refine the comprehension index and the learning progress index.

Input: New response information, new behavior information, current indexes.

Output: Further updated comprehension index and learning progress index.

Server rescales topic-wise scores, recalculates mastery probabilities, and updates per-skill performance vectors; server writes these updated values into the learner state record, improving its internal representation of the learner's knowledge.

### Step 16

Server adjusts subsequent prompt sentences and content generation.

Server uses the latest indexes and any change in the emotion index to modify future prompt generation rules and generation conditions.

Input: Updated learner state and logged relationships of past prompts and outcomes.

Output: Adjusted prompt sentence parameters and content generation settings.

Server evaluates whether the difficulty should be increased, maintained, or reduced, and modifies which index elements are emphasized in the next prompt sentence; for example, when the emotion index indicates frustration and the comprehension index remains low, server generates an emotion-aware prompt such as: “The user is an intermediate English learner who has difficulty with relative clauses and is currently showing signs of frustration (frequent frowning, low quiz accuracy). Please generate a short, very simple explanation of relative clauses with clear step-by-step examples, followed by 3 easy practice questions. Use supportive and encouraging language.”

Server stores these new prompt generation parameters for use in later invocations of the generative AI model.

### Step 17

Server logs prompt-content-outcome relationships for later optimization.

Server records, in persistent storage, each prompt sentence, the associated generated content, and subsequent performance and emotion indexes.

Input: Prompt sentences, generated learning content information, performance information, emotion index values.

Output: Log records linking prompts, content, and outcomes.

Server inserts log entries into one or more tables, each entry containing identifiers, timestamps, index snapshots, and summary statistics, thereby creating a dataset used to refine prompt generation rules and model control strategies in future processing cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

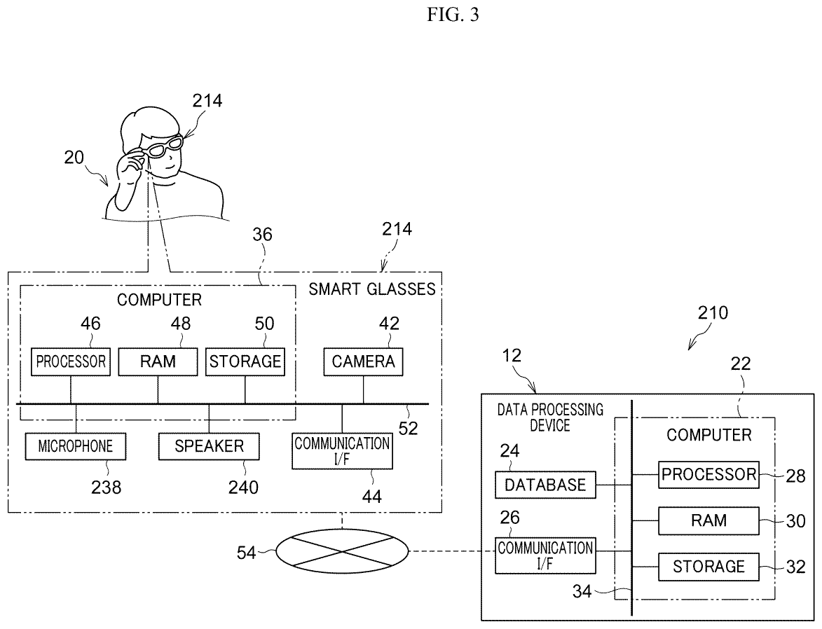

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

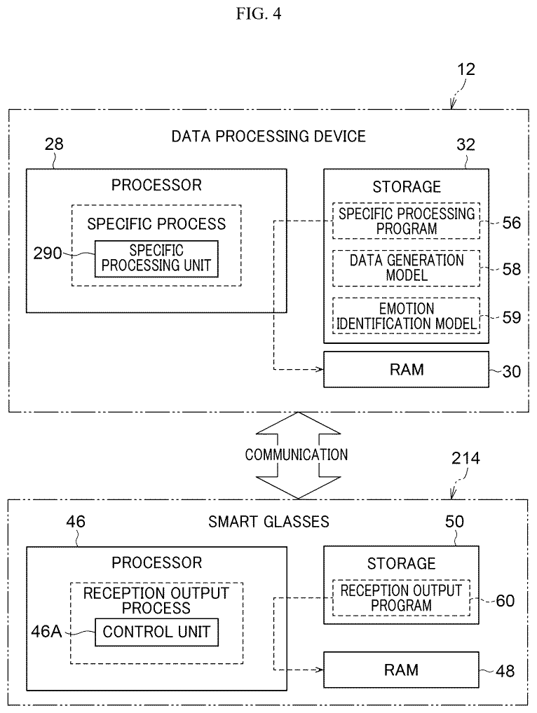

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

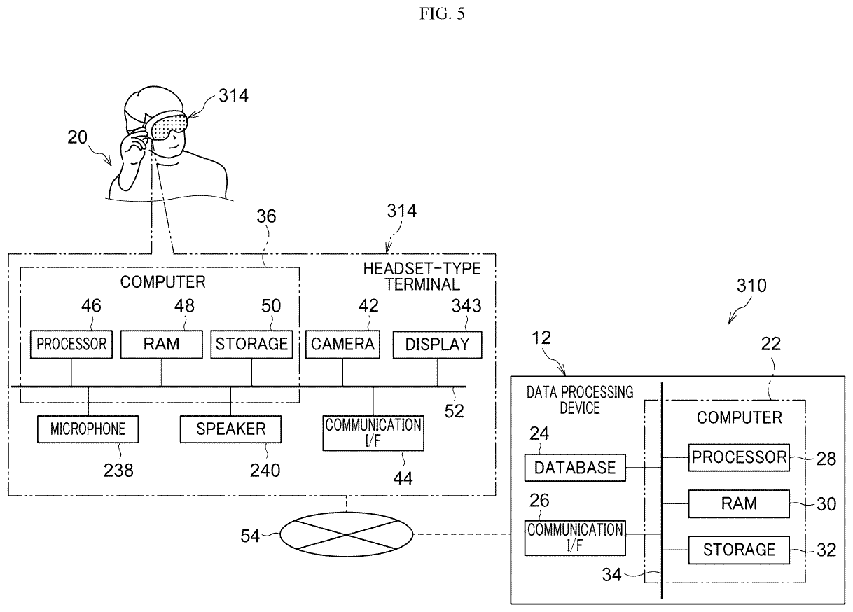

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

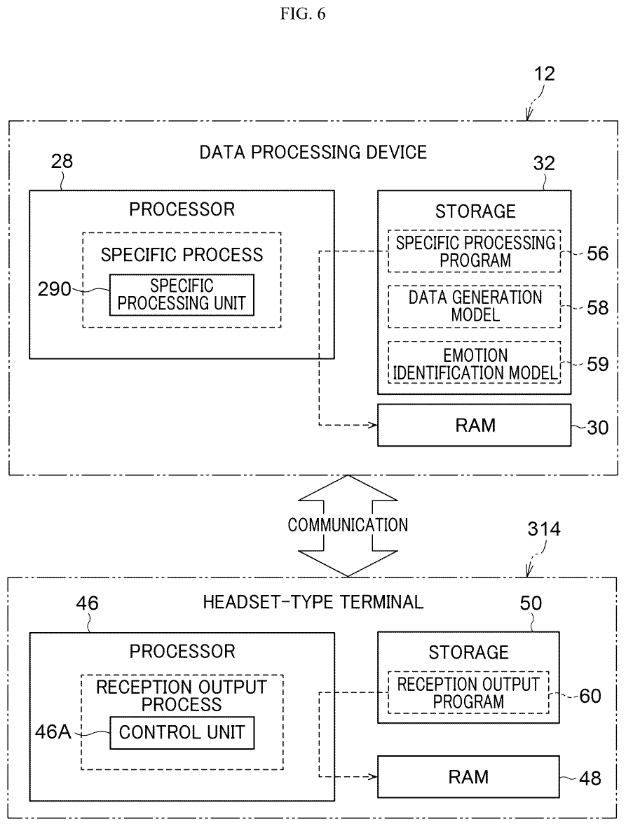

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

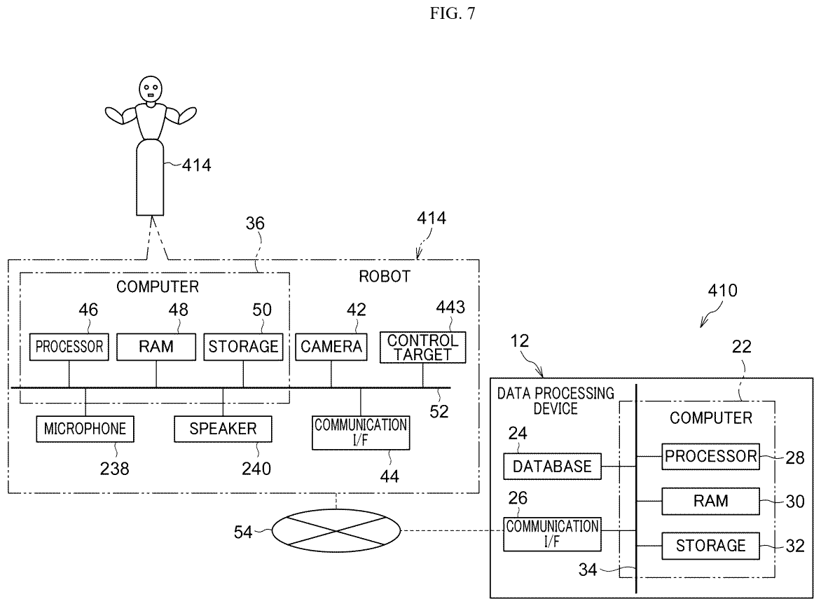

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

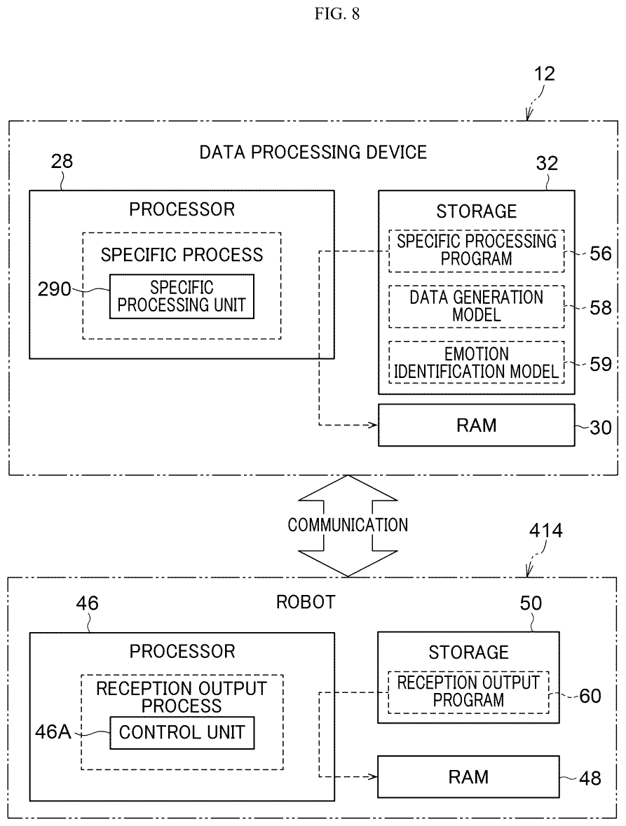

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

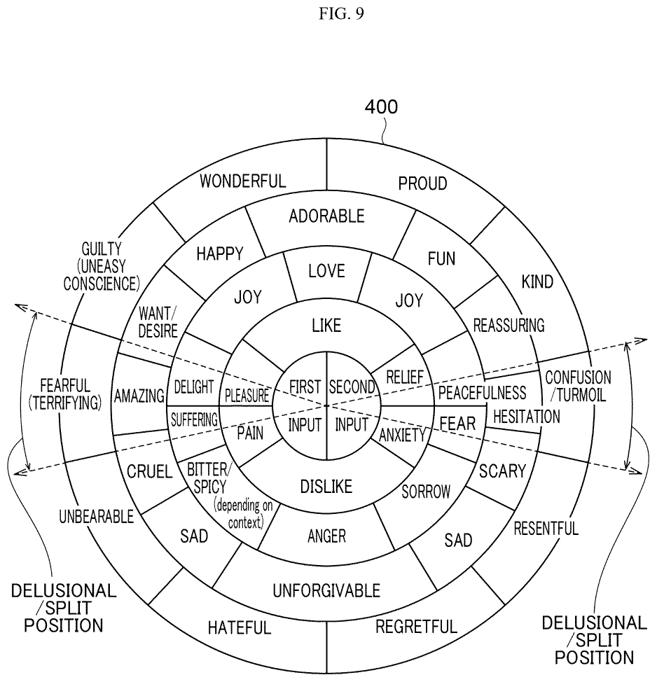

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

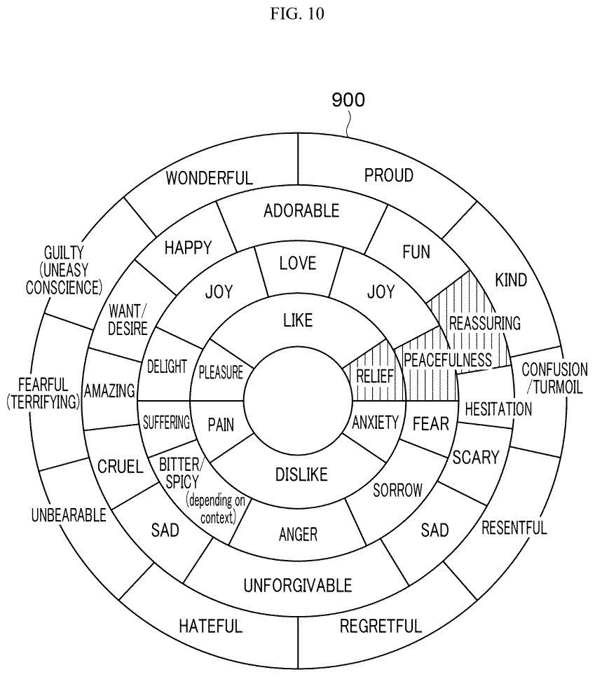

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire learner input information including a text passage and an answer from a terminal device,
preprocess the acquired learner input information by normalizing character strings, segmenting the character strings into word units, removing unnecessary words, and converting the preprocessed data into an analysis data structure,
calculate statistical features and syntactic features based on the analysis data structure, and
calculate a difficulty index of the text passage based on the statistical features and the syntactic features,
generate an evaluation input including the text passage and the learner answer as a prompt sentence in a natural language format, input the prompt sentence into a generative AI model, and obtain evaluation information relating to a comprehension level of the learner from an output of the generative AI model,
classify words included in the text passage and the learner answer based on frequency information or vocabulary level information, and calculate a vocabulary usage level as a numerical value or a stage,
integrate the difficulty index, the evaluation information relating to the comprehension level, and the vocabulary usage level, select a learning text or a problem adapted to an ability level of the learner, and generate presentation information including the selected learning text or the selected problem,
transmit the presentation information to the terminal device and cause the terminal device to display an evaluation result and learning content, and
generate a prompt sentence for the generative AI model based on the evaluation information relating to the comprehension level and learning history information, and automatically generate interactive questions for comprehension checking by using the prompt sentence with the generative AI model.

### Supplementary 2

The system according to supplementary 1,
wherein the processor is configured to
store, in a storage device, the learner input information, the difficulty index, the evaluation information relating to the comprehension level, and the vocabulary usage level in time series, calculate learning progress based on stored information, and automatically update learning content to be presented by dynamically changing a condition or a parameter of the prompt sentence to be input into the generative AI model in accordance with the calculated learning progress.

### Supplementary 3

The system according to supplementary 1,
wherein the processor is configured to
when the evaluation information relating to the comprehension level obtained from the generative AI model is within a predetermined range, automatically generate, based on the evaluation information and the difficulty index, at least one of a follow-up question for additional input, an explanatory text, and a candidate for a next learning task, and present the at least one of the follow-up question, the explanatory text, and the candidate for the next learning task to the terminal device.

### Application Example 1

### Supplementary 1

A system comprising a processor,
wherein the processor is configured to
acquire response information and behavior information of a learner from a storage device in order to evaluate vocabulary ability and comprehension ability of the learner, analyze linguistic feature information and structural feature information of learning target text including the response information and the behavior information by using a natural language processing function, and calculate, as numerical values, a vocabulary index and a comprehension index for each learner based on a result of the analysis,
search an information storage device in which a plurality of learning texts are stored together with difficulty information by using the vocabulary index and the comprehension index,
select a learning text suitable for the learner based on a relationship between the difficulty information and the vocabulary index and the comprehension index, and distribute the selected learning text to a terminal device,
generate input text including the vocabulary index and the comprehension index, summary information relating to the learning text, and learning purpose information, input the input text to a generative information processing model as a generative AI model to cause the generative information processing model to generate a prompt sentence corresponding to the learning text, evaluate expression difficulty of the generated prompt sentence by the natural language processing function, and distribute to the terminal device a prompt sentence whose evaluation result falls within a predetermined range,
generate, based on a difference between the vocabulary index and the comprehension index and the difficulty information of the learning text, rewrite instruction text that instructs the generative information processing model to generate a rewritten version of the learning text while maintaining semantic content of the learning text and causing vocabulary difficulty and syntactic difficulty to converge to a target range, input the rewrite instruction text to the generative information processing model to cause the generative information processing model to generate a difficulty-adjusted learning text, re-evaluate difficulty of the difficulty-adjusted learning text by the natural language processing function, and distribute the difficulty-adjusted learning text to the terminal device in a case where a result of the re-evaluation falls within the target range, and
execute correctness determination processing and semantic similarity calculation processing based on input responses, reaction time information, and operation history information of the learner acquired from the terminal device, update the vocabulary index and the comprehension index according to results of the correctness determination processing and the semantic similarity calculation processing, store the updated vocabulary index and the updated comprehension index in the storage device as learning history, and automatically change difficulty of the learning text and the prompt sentence to be provided in a subsequent learning session based on the learning history.

### Supplementary 2

The system according to supplementary 1,
wherein the processor is configured to
generate interactive question information or problem information according to a learning situation of the learner by inputting, to the generative information processing model as the generative AI model, input text including the vocabulary index, the comprehension index, and description information indicating the learning text, acquire a question sentence and an option sentence or a descriptive answer instruction sentence output from the generative information processing model, evaluate difficulty and content suitability of the question sentence by the natural language processing function, and distribute, to the terminal device, a question sentence adopted based on a result of the evaluation.

### Supplementary 3

The system according to supplementary 1,
wherein the processor is configured to
record, as progress information, for each learning session, start time, end time, identification information of a viewed text, answer result information, and the vocabulary index and the comprehension index acquired from the terminal device, estimate, based on the progress information, a recommended difficulty band and a recommended learning field for each learner, and automatically change selection of the learning text and generation conditions of the prompt sentence according to an estimation result.

### Example 2

### Supplementary 1

A system comprising a processor,
wherein the processor is configured to
acquire, on the basis of identification information of a learning subject and request information regarding a learning field, response history information and behavioral history information of the learning subject from an information storage device, and
preprocess acquired text information and correctness information by using natural language processing technology and statistical processing technology, and calculate word occurrence frequency, vocabulary diversity, and vocabulary difficulty indices so as to numerically evaluate a vocabulary ability level and a comprehension ability level of the learning subject, and
automatically generate a prompt sentence, which is an instruction sentence to be input to a generative AI model, on the basis of an evaluation result and the request information regarding the learning field, by using a predefined sentence template and character string processing, and
transmit the prompt sentence to the generative AI model and obtain, from the generative AI model by natural language generation processing, an explanation text and learning content having a difficulty level corresponding to the evaluation result, and
convert the obtained explanation text and learning content into a data structure transmittable to an output device and distribute the data structure to an information processing terminal for the learning subject, and
append response result information and operation history information of the learning subject to the information storage device and reflect appended information in subsequent evaluations and subsequent automatic generation of the prompt sentence.

### Supplementary 2

The system according to supplementary 1,
wherein the processor is configured to
additionally generate a prompt sentence for generating interactive problem information including comprehension-check questions and options, on the basis of the explanation text obtained from the generative AI model, and input the prompt sentence to the generative AI model so as to generate problem content including a plurality of questions and correct answer information, and distribute the problem content to the information processing terminal for the learning subject.

### Supplementary 3

The system according to supplementary 1,
wherein the processor is configured to
calculate a learning progress index on the basis of learning history information stored in the information storage device, and automatically change difficulty designation information and amount designation information in the prompt sentence in accordance with the learning progress index and the vocabulary ability level and the comprehension ability level, thereby continuously updating the learning content obtained from the generative AI model.

### Application Example 2

### Supplementary 1

A system comprising a processor,
wherein the processor is configured to
acquire response information and behavior information of a learner from a storage device in order to analyze a vocabulary capability and a comprehension capability of the learner,
analyze the response information by using a natural language processing function to calculate a vocabulary index and a comprehension index, and analyze the behavior information to calculate a learning progress index,
acquire image information and audio information transmitted from a terminal device in order to estimate an emotional state of the learner, extract facial expression features and audio features by using an image processing function and an audio processing function, and calculate an emotion index based on the facial expression features and the audio features,
generate a prompt sentence to be input to a generative artificial intelligence model based on the vocabulary index, the comprehension index, the learning progress index, and the emotion index, input the prompt sentence to the generative artificial intelligence model to cause the generative artificial intelligence model to generate learning content information, and provide the generated learning content information to the terminal device,
acquire response information of the learner to interactive questions or quizzes transmitted from the terminal device, reflect the response information in updating the learning progress index and the comprehension index, and automatically change the prompt sentence and the learning content information in accordance with an update result, and
record the prompt sentence input to the generative artificial intelligence model, the learning content information output from the generative artificial intelligence model, and performance information and the emotion index of the learner with respect to the learning content information in association with one another, and update a generation rule of the prompt sentence or a generation condition of the learning content information based on the record.

### Supplementary 2

The system according to supplementary 1,
wherein the processor is configured to
generate planning information that determines a next learning unit or a type and a difficulty level of a next task based on the learning progress index, the comprehension index, and the emotion index, generate lesson configuration information corresponding to the planning information as a prompt sentence for the generative artificial intelligence model, and cause the generative artificial intelligence model to generate the learning content information including explanation information and practice problem information based on the lesson configuration information.

### Supplementary 3

The system according to supplementary 1,
wherein the processor is configured to
input a prompt sentence including the emotion index and the comprehension index to the generative artificial intelligence model when the emotion index satisfies a predetermined condition, cause the generative artificial intelligence model to generate feedback information including an encouraging expression and review learning content information with an adjusted difficulty level, and cause the terminal device to present the feedback information and the review learning content information.

What is claimed is:

1. A system comprising:
circuitry configured to:
receive, via a communication interface coupled to a packet-switched network, input data comprising a text passage and a response input from a terminal device, preprocess the input data by normalizing character strings, segmenting the character strings into word units, removing non-content tokens, and converting the preprocessed data into an analysis data structure;
compute statistical features and syntactic features from the analysis data structure, and compute a difficulty index of the text passage based on the statistical features and the syntactic features;
generate an evaluation prompt sentence in natural language format incorporating the text passage and the response input as an evaluation objective, input the evaluation prompt sentence to a generative neural network model, and receive evaluation data relating to a comprehension level from the generative neural network model;
classify words included in the text passage and the response input based on frequency data or vocabulary level data to compute a vocabulary usage level;
integrate the difficulty index, the evaluation data, and the vocabulary usage level to select content data adapted to an ability level of a user and generate presentation data including the selected content data, and transmit the presentation data to the terminal device; and
generate a further prompt sentence for the generative neural network model based on the evaluation data and interaction history data stored in a storage device, and input the further prompt sentence to the generative neural network model to generate interactive question data for transmission to the terminal device.

2. The system according to claim 1, wherein the circuitry is configured to apply a character string normalization algorithm to the input data to standardize character encodings and case formats, apply a word segmentation algorithm to partition normalized character strings into word unit sequences, and apply a stop-word removal algorithm to eliminate non-content tokens from the word unit sequences prior to computing the statistical features.

3. The system according to claim 2, wherein the circuitry is configured to compute the statistical features by calculating a type-token ratio, an average sentence length, and a lexical density from the word unit sequences, and compute the syntactic features by applying a dependency parsing algorithm to generate syntactic dependency trees and computing a syntactic complexity score from the dependency tree depth.

4. The system according to claim 3, wherein the circuitry is configured to compute the difficulty index by applying a weighted combination function to the statistical features and the syntactic features, wherein weights of the weighted combination are stored in the storage device and are updated based on historical evaluation data accumulated over prior processing cycles.

5. The system according to claim 4, wherein the circuitry is configured to classify words in the text passage using a vocabulary frequency list indexed by frequency band identifiers, assign each word to a frequency band, compute the vocabulary usage level as a weighted sum of frequency band membership counts, and store the vocabulary usage level in the storage device in association with the interaction history data.

6. The system according to claim 1, wherein the circuitry is configured to generate the evaluation prompt sentence by selecting a prompt template based on a content type parameter, substituting the text passage and the response input into the prompt template, and appending output format specifications requiring the generative neural network model to output a structured evaluation record comprising at least a comprehension score, identified comprehension gaps, and feedback text.

7. The system according to claim 6, wherein the circuitry is configured to parse the structured evaluation record received from the generative neural network model to extract the comprehension score, the identified comprehension gaps, and the feedback text, and store the extracted data as evaluation data in the storage device in association with the interaction history data and a timestamp.

8. The system according to claim 7, wherein the circuitry is configured to generate the further prompt sentence by retrieving a subset of the stored interaction history data corresponding to a rolling window of prior processing cycles, constructing a context representation from the retrieved subset, and appending the context representation and the identified comprehension gaps to a question-generation prompt template.

9. The system according to claim 8, wherein the circuitry is configured to input the further prompt sentence to the generative neural network model to generate a plurality of interactive question data items, apply a question diversity evaluation algorithm to the plurality of interactive question data items to ensure coverage of identified comprehension gaps, and select a subset of the plurality of interactive question data items with maximum coverage for transmission to the terminal device.

10. The system according to claim 1, wherein the circuitry is configured to receive emotional state data from the terminal device comprising at least one of facial expression data or interaction pattern data, apply an emotion estimation algorithm to the emotional state data to generate an emotion state parameter, and adjust at least one of a difficulty level selection criterion or a content type selection criterion based on the emotion state parameter.

11. The system according to claim 10, wherein the circuitry is configured to detect a change in the emotion state parameter exceeding a state-change threshold between consecutive processing cycles, regenerate the evaluation prompt sentence or the further prompt sentence incorporating the updated emotion state parameter as an adjustment condition, and supply the regenerated prompt sentence to the generative neural network model.

12. The system according to claim 1, wherein the circuitry is configured to apply a time-series analysis algorithm to the stored interaction history data to compute a longitudinal ability-level trajectory, incorporate the longitudinal ability-level trajectory into the further prompt sentence as a performance trend condition, and receive adaptive content data from the generative neural network model that reflects the performance trend.

13. The system according to claim 12, wherein the circuitry is configured to detect a statistically significant improvement or decline in the longitudinal ability-level trajectory, adjust the difficulty index selection threshold based on the detected trend, and store the adjusted threshold in the storage device for application to subsequent content selection.

14. The system according to claim 1, wherein the circuitry is configured to generate a progress report prompt sentence incorporating accumulated evaluation data from the storage device, input the progress report prompt sentence to the generative neural network model, receive a natural language progress report, and transmit the progress report to the terminal device.

15. The system according to claim 14, wherein the circuitry is configured to apply a hallucination detection algorithm to the progress report by comparing key performance metrics in the report against stored evaluation data, flag report segments containing inconsistent performance claims, and regenerate flagged segments by supplying a correction prompt sentence to the generative neural network model.

16. The system according to claim 1, wherein the circuitry is configured to receive a batch of input data comprising a plurality of text passage and response input pairs from the terminal device, process each pair through the preprocessing, statistical feature computation, and evaluation steps in parallel, and store results from each pair as evaluation records in the storage device indexed by a session identifier.

17. The system according to claim 1, wherein the circuitry is configured to generate a content adaptation prompt sentence incorporating the difficulty index, the vocabulary usage level, and the emotion state parameter received from the terminal device, input the content adaptation prompt sentence to the generative neural network model to generate adapted content data at an adjusted difficulty level, and transmit the adapted content data to the terminal device.

18. A system comprising:
circuitry configured to:
receive, via a communication interface coupled to a packet-switched network, input data comprising a text passage and a response input from a terminal device, preprocess the input data into an analysis data structure, and compute statistical features and syntactic features to generate a difficulty index;
generate an evaluation prompt sentence incorporating the text passage and the response input, input the evaluation prompt sentence to a generative neural network model, and receive evaluation data comprising a comprehension score, identified comprehension gaps, and feedback text;
classify words in the text passage and the response input to compute a vocabulary usage level, integrate the difficulty index, the evaluation data, and the vocabulary usage level to select content data adapted to an ability level of a user, and transmit presentation data including the selected content data to the terminal device; and
generate a further prompt sentence based on the evaluation data and interaction history data, input the further prompt sentence to the generative neural network model to generate interactive question data, and transmit the interactive question data to the terminal device.

19. The system according to claim 18, wherein the circuitry is configured to receive emotional state data from the terminal device, apply an emotion estimation algorithm to generate an emotion state parameter, and adjust at least one of a difficulty level selection criterion or a content type selection criterion based on the emotion state parameter.

20. A method performed by circuitry, the method comprising:
receiving, via a communication interface coupled to a packet-switched network, input data comprising a text passage and a response input from a terminal device, preprocessing the input data by normalizing character strings, segmenting the character strings into word units, removing non-content tokens, and converting the preprocessed data into an analysis data structure;
computing statistical features and syntactic features from the analysis data structure, and computing a difficulty index of the text passage based on the statistical features and the syntactic features;
generating an evaluation prompt sentence in natural language format incorporating the text passage and the response input as an evaluation objective, inputting the evaluation prompt sentence to a generative neural network model, and receiving evaluation data relating to a comprehension level from the generative neural network model;
classifying words included in the text passage and the response input based on frequency data or vocabulary level data to compute a vocabulary usage level;
integrating the difficulty index, the evaluation data, and the vocabulary usage level to select content data adapted to an ability level of a user and generating presentation data including the selected content data, and transmitting the presentation data to the terminal device; and
generating a further prompt sentence for the generative neural network model based on the evaluation data and interaction history data stored in a storage device, and inputting the further prompt sentence to the generative neural network model to generate interactive question data for transmission to the terminal device.
